(19) United States
(12) Patent Application Publication
(10) Pub. No.: US 2004/0013097 A1
(43) Pub. Date: Jan. 22, 2004

(54) Wireless communication

(76) Inventor: Massimo Massa, Victoria (AU)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/362,851

(22) PCT Filed: Aug. 29, 2001
(86) PCT No.: PCT/AU01/01087

(30) Foreign Application Priority Data
Aug. 29, 2000 (AU) PQ 9703

(51) Int. Cl. H04B 7/216; H04L 29/10

(52) U.S. Cl. 370/335

(57) ABSTRACT

A wireless communication system network, including a plurality of wireless communication system apparatuses, for use on unlicensed frequency such as a Code Division Multi Access (CDMA) frequency wherein the apparatuses are able to accept one of a plurality of protocols and convert to a predetermined transmission protocol which by the use of code spread spectrum transmission is able either: to transmit the signal to a telehouse for receipt and interpretation of the code to resend to another apparatus by code spread spectrum transmission where it is received and selectively converted and outputted into a required one of a plurality of protocols; or to transmit and be received by one or more other apparatuses encoded with the same transmission code to form a virtual private network where the transmitted signal can be outputted into one of a plurality of protocols.

### FIELD OF THE INVENTION

This invention relates to a wireless communication system formed of a remote telecommunication device, which comes in different models.

### CROSS REFERENCE

This application is related to Australian provisional application no. PQ9703 filed on Aug. 29, 2000 and the disclosure of that application is incorporated herein by reference thereto.

### BACKGROUND OF THE INVENTION

Today's society demands affordable high-speed communication. With the increasing importance of the Internet and public and private networks for communication, e-commerce, and information exchange, the volume of voice and high-speed data traffic worldwide has increased dramatically. Slow, ineffective video conferencing is no longer acceptable. Users require real-time, quality motion pictures accompanied with voice, at a competitive price.

Corporate and domestic environments alike require speedy, versatile and reliable communications, which are easy to implement and user friendly. The necessity for mobility has become the demand for the future. Wireless technologies are the essence of mobility. Just like mobile telephones are the necessity of every businessman today, so are mobile offices where anything from accessing electronic files, to booking an airline ticket from a remote site is mandatory in today's fast business world.

Communication today is dominated by cabled infrastructures that are limited in many ways. It is obvious that cables will not provide mobility. The conventional ‘final tails’ to the telephony network dates to the early 1900's. They are made of copper wire and were designed for analogue transmission. Upon us today is the age of information technology and telecommunications requires more than telephony. It consists of a number of different instruments such as computers, Internet and cellular phones etc. However, due to the large existing copper wire infrastructure that was implemented for analogue signal only, some devices were developed to access those analogue lines for the digital telecommunication purpose. For example, existing computer modems utilise the conventional telephony network to enable communications to the Internet or to send faxes. However, the copper wire is limited to delivering a maximum of 14.4 Kbps of data, even though modems are designed for 56 Kbps. This means the modem compresses the data at a rate of 56 Kbps to enable it to go through at 14.4 Kbps.

Optic fibre has recently replaced copper wires in such situations where the capacity demand is greater. Replacing those copper pairs with optical fibres would be a good way to speed up Internet access, but cannot be economically justified for residential and small business customers. Even in the case of medium-sized and large businesses, which can afford to spend thousands of dollars on communications every month, a more economical and effective alternative is needed.

Using technology that allows operation at speeds up to 9 Gbps this method of transmission incurs significant costs. These costs involve laying the cable, and in purchasing the terminal boxes that access the optic fibre. Because the location of the optic fibre is dependent on the telecom's opinion, in many cases users will not have access to it. Optic fibre constitutes a small percentage of the telecommunication infrastructure as is too expensive to install in rural towns, therefore has limited coverage.

Microwave links are a form of wireless communications with significant restrictions. It is important to note that the wireless communication system is different from the microwave link. Microwave uses much higher frequencies and has to be transmitted at high wattage. It is easily affected by weather and transmission is limited to one protocol. It uses licensed frequencies and special transceivers and is therefore very expensive to operate.

### DISCLOSURE OF THE INVENTION

In accordance with the invention there is provided A wireless communication system for use on unlicensed frequency such as the Code Division Multi Access (CDMA) frequency, the system including a first interfacing unit able to interface with a selected input from a plurality of different protocol inputs including voice and data inputs as selected at the first interfacing unit, a multiplexer for converting the various different protocols to one or more predetermined transmission protocols; a router for prioritizing inputs to determine the order of transmission according to a predetermined priority and system requirements; a radio converter enabling spread spectrum transmission over a set open multi access frequency, with the converter modifying the frequency spectrum of the data-signal to be transmitted by spreading the signal using a code uncorrelated with that signal; a radio transmitter for transmitting the spread spectrum data-signal;

a complementary radio receiver for receiving the transmitted data-signal;

a complementary radio converter for converting the transmitted data-signal to the one or more selected transmission protocols; a multiplexer for converting the one or more selected transmission protocols to a selected protocol; and a second interfacing unit able to output a selected one of a plurality of different protocol outputs.

The first interfacing unit can interface with a plurality of different protocol inputs including serial port, analogue voice, digital voice, internet modem, Ethernet, and video conferencing. In particular in one embodiment the first interfacing unit is able to interface with a plurality of different protocol inputs including:

Serial V.35, V.24, X.21,

analog voice—FXS, FXO, and E&M; 2-wire and 4-wire, voice compression support including

ACELP II (5.8 Kbps, 8 Kbps), G.726 ADPCM (16, 24, 32 & 40 Kbps), G.711 PCM (64 Kbps), and G.729 (8 Kbps) in Release 3.0;

digital voice—T1: digital, ISDN PRI, CAS—T1—up to 24 channels, E1: MFCR-2, R2, CAS—E1—up to 30 channels.

56K, 64K, T1, and E1 DSU.

ISDN BRI—S/T or U interface, data and voice.

V.34 modem.

Ethernet 10BaseT.

Fast Ethernet 100BaseTx.

Token Ring, STP and UTP.

T1 or E1 ATM interface; and

H320 Video Conferencing

The radio converter operates by reference to the code modifies the frequency spectrum of the data-signal to be transmitted across the entire bandwidth of the transmittal frequency. The code used by the radio converter to modify the frequency spectrum of the data-signal to be transmitted can be related to a group of users whereby only the group of users can transmit and receive data-signals from each other. Alternatively the code used by the radio converter to modify the frequency spectrum of the data-signal to be transmitted can be related to a single of user whereby only the single user and a main gateway can transmit and receive data-signals from each other, with the gateway able to resend to another user as identified in the data-signal by use of a separate code relevant to the intended recipient.

The wireless communication system can use the transmission protocol of TCIP/IP.

Also in accordance with the invention there is provided a wireless communication system network, including a plurality of wireless communication system apparatuses, for use on unlicensed frequency such as a Code Division Multi Access (CDMA) frequency wherein the apparatuses are able to accept one of a plurality of protocols and convert to a predetermined transmission protocol which by the use of code spread spectrum transmission is able either: to transmit the signal to a telehouse for receipt and interpretation of the code to resend to another apparatus by code spread spectrum transmission where it is received and selectively converted and outputted into a required one of a plurality of protocols; or to transmit and be received by one or more other apparatuses encoded with the same transmission code to form a virtual private network where the transmitted signal can be outputted into one of a plurality of protocols.

This system network can use a plurality of the wireless communication system apparatuses as hereinbefore described.

To further improve operation of the wireless communication system, the radio transmitter or receiver is connected to an amplifier to increase the power of the transmitted or received data-signals.

The wireless communication system is a wireless, high capacity transfer system for data, voice, and video transmission. It provides an alternative to existing land-based cables and microwave communication networks at an affordable price. The wireless communication system networks are based on simple star-topology or point-to-point designs and consist of two basic building blocks: the radio and computer components (refer to FIG. 3). Its unique features include:

1. High Transmission Capacity—Bypassing the restriction of land based cables (14.4 Kbps); the wireless communication system is able to achieve a throughput of 11 Mbps. It has the ability of delivering different amounts of bandwidth with a selection of interfaces.

2. Easy Interfacing—The wireless communication system has a universal interface. It has the ability to simultaneously interface and integrate with various data devices.

3. Rapid installation—The wireless communication system systems are shipped off-the-shelf, easy to install and reliable. There is no necessity to rewire the existing network. By using License Exempt Frequencies, it eliminates many of the time-consuming processes required in planning and co-coordinating. It also eliminates the problems associated with geographic challenges and properties that are hard to wire.

4. Interference & Security—The wireless communication system uses Direct Sequence Spread-Spectrum technology (DSSS) and open proprietary networking architecture modulation for wireless networks. Spread Spectrum Technology is able to eliminate the interference from other unlicensed band users. With single path control algorithm (STP) and flexibility in the frequency adjustment. The wireless communication system networks are robust and jam resistant, are secure, preventing eaves dropping, and are free from weather interference. More importantly, there is no necessity to replace any existing equipment.

5. Scalable Design—The wireless communication system offers a scalable design. A smaller wireless communication system model can deliver 64 Kbps for a domestic environment, or be extended, but not limited to 11 Megs for corporate applications.

6. Distance—Users can reach up to 20 km with high-grain directional antennas, and can extend to 30 km if an amplifier is added. Long-range models can reach up to 65 km. With its flexibility in frequencies, the range can be extended to a ‘global coverage’ either through the establishment of a local carrier or with the use of the C Band frequency in satellite communications.

7. Competitive Pricing—The unique features of the wireless communication system mean that it has a superior cost-to-capacity ratio. Its ability to expand and be scaled up incrementally as groups of new customers sign up, means that it requires minimal initial installation costs. The high cost of burying copper lines, optic fiber or microwave is eliminated. The use of License Exempt Frequencies reduces the daily operating cost effectively. (The fee of obtaining an exclusive license for a frequency can cost anywhere between $5,000,000 to $100,000,000. The ISM S band frequency has been recently designated by international communication authorities to be free as long as the operation is within the parameters of 4 watts and 2,400.0 to 2,483.5 MHz).

8. Other Features—The wireless communication system technology can be used to form a Wireless Loop Infrastructure (WLI). The wireless loop is made out of access cells (towers) that have no limitations in accessing a number of subscribers, just like a mobile telephone network. For example, a mobile cell site will accept any mobile phone calls communicating to that cell site. However, its limitation will be when an excessive number of users have reached, therefore slowing down the network.

The wireless communication system has been designed to have the intelligence and bandwidth manageability, to enable the formation of a large Wireless Loop Infrastructure, blanketing an entire city and providing a wireless service to end user subscribers with no limitations; such as mobility and variable bandwidth. Due to its high receiver sensitivity, the user may receive signals where the wireless communication system wireless infrastructure signal may be weak. The wireless communication system has the intelligence to work out the congestion ratio per access cell. Because data is being transmitted, some users may use more bandwidth than others, so it is impossible to determine the number of users that can work simultaneously out of one access cell.

The wireless communication system can manage a variable bandwidth to accommodate users that are using the network to transmit various amounts of data. The access cell has the ability to deliver (but is not limited to) 11 Mbps, meaning it will communicate to the subscriber's The wireless communication system at a rate of 56 Kbps to 512 Kbps, uncompressed, but also vary on demand. The wireless communication system may also broadcast the service to a mobile unit. This means that the remote site does not require the programming of its position and the input of its latitude and longitude. This service is very useful for curriers, public services, etc. The Wireless Loop Infrastructure has the ability to prioritise voice over data when required.

The software that runs the access cells and the subscriber's the wireless communication system, may be upgraded by a remote site. In addition, bandwidth may be adjusted from the remote site via software as per customer demands. The transceiver design of the wireless communication system has the ability to transmit any protocol, therefore has a transparent MAC layer. This means that it may not only transmit TCP/IP protocol (Internet protocol), but also other protocols. Having this feature, the wireless communication system has also a modular universal interface. The access cells may be bandwidth managed and where you may address layer by layer so that you may dedicate a certain bandwidth to a secondary access cell, or to dedicate a DAL (Dedicated Access Line) to a special customer.

### BRIEF DESCRIPTION OF THE DRAWINGS

In order that the invention may be more readily understood various embodiments will be described by way of illustration only with reference to the drawings wherein:

FIG. 1 is a diagrammatic view of a conventional network of the prior art.

FIG. 2 is a diagrammatic view of a wireless communication system network in accordance with the invention.

FIG. 3 is a diagrammatic view of a wireless communication system apparatus for use in the network of FIG. 2 in accordance with the invention.

FIG. 4 is a diagrammatic view of a wireless communication system network in accordance with the invention in connection with a conventional network.

FIG. 5 is a diagrammatic view of a wireless communication system apparatus for use in the network of FIG. 2 in accordance with the invention showing the multiple protocol input/output.

FIG. 6 is a diagrammatic view of a first embodiment of a wireless communication system apparatus for use in the network of FIG. 2 in accordance with the invention.

FIG. 7 is a diagrammatic view of second embodiment of a wireless communication system apparatus for use in the network of FIG. 2 in accordance with the invention.

FIG. 8 is a diagrammatic view of a point-to-point communication aspect of wireless communication system for use in the network of FIG. 2 in accordance with the invention.

FIG. 9 is a diagrammatic view of a wireless communication system apparatus for use in branch office networking with the network of FIG. 2 in accordance with the invention.

FIG. 10 is a diagrammatic view of a wireless communication system network of FIG. 2 in accordance with the invention as it replaces existing leased lines of known communication systems.

FIG. 11 is a diagrammatic view of a wireless communication system virtual private network through a traditional wired infrastructure.

FIG. 12 is a diagrammatic view of a wireless communication system virtual private network using the wireless communication system apparatus of FIG. 3.

FIG. 13 is a diagrammatic view of a wireless communication system virtual private network using the wireless communication system apparatus of FIG. 3 in combination with known networks.

FIG. 14 is a diagrammatic view of a wireless communication system virtual private network as shown in FIG. 13 using the wireless communication system apparatus of FIG. 3 in combination with known networks.

FIG. 15 is a diagrammatic view of a wireless communication system virtual private network as shown in FIG. 13 using the wireless communication system apparatus of FIG. 3 in combination with known networks.

FIG. 16 is a diagrammatic view of a wireless communication system virtual private network as shown in FIG. 13 using the wireless communication system apparatus of FIG. 3 in combination with known networks.

FIG. 17 is a diagrammatic view of a wireless communication system virtual private network as shown in FIG. 13 using the wireless communication system apparatus of FIG. 3 in combination with known networks.

FIGS. 18 to 34 are diagrammatic views of the MUX unit of the wireless communication system apparatus as shown in FIG. 3 for use in the network of FIG. 2 in accordance with the invention.

FIG. 35 is a diagrammatic view of the transceiver unit of the wireless communication system apparatus as shown in FIG. 3 for use in the network of FIG. 2 in accordance with the invention.

### MODE FOR CARRYING OUT THE INVENTION

Telecommunications are on the verge of an unprecedented wave of infrastructure investments fuelled by the dramatic growth of the Internet and the comprehensive replacement of existing line based networks. It has become a necessity for telephone companies, cable operators, and ISPs to merge and establish new public network infrastructures. The merging of services accommodates a greater diversity of applications, customer types, and media formats. The central issue for the network is quality of service. That means providing multiple diverse service levels, including guaranteed performance levels, on a shared infrastructure, along with all the resource management, provisioning, and engineering tools that this requires. The unique features of the wireless communication system are ideal to meet this challenge.

Hardware

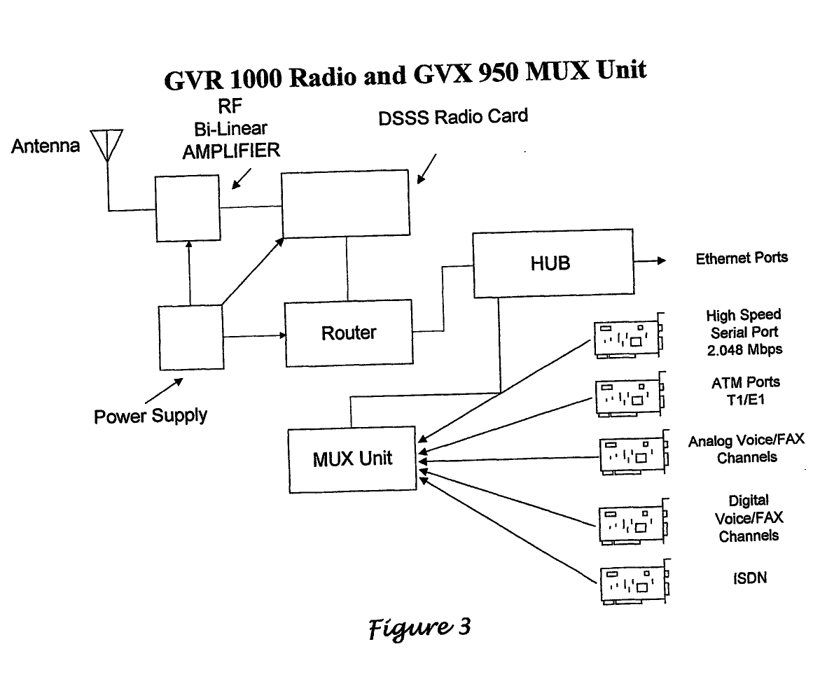

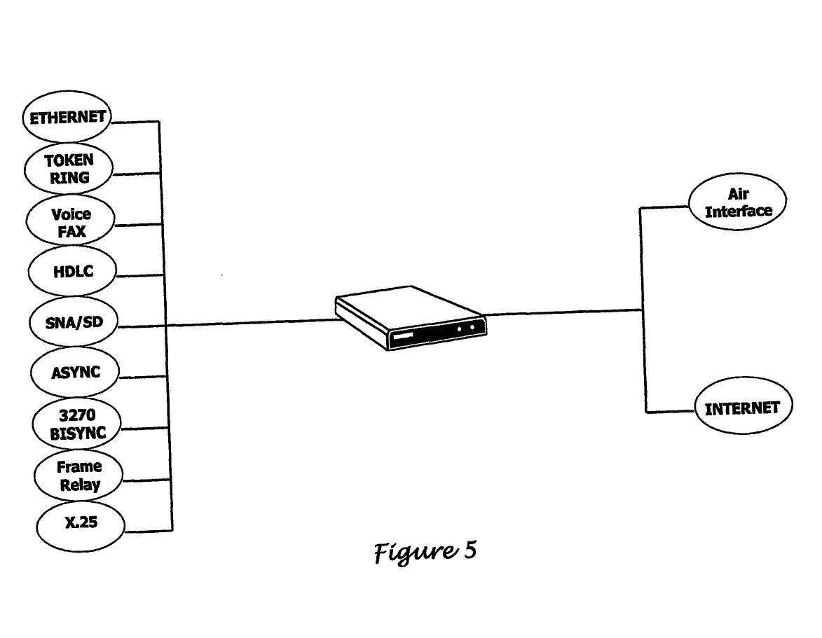

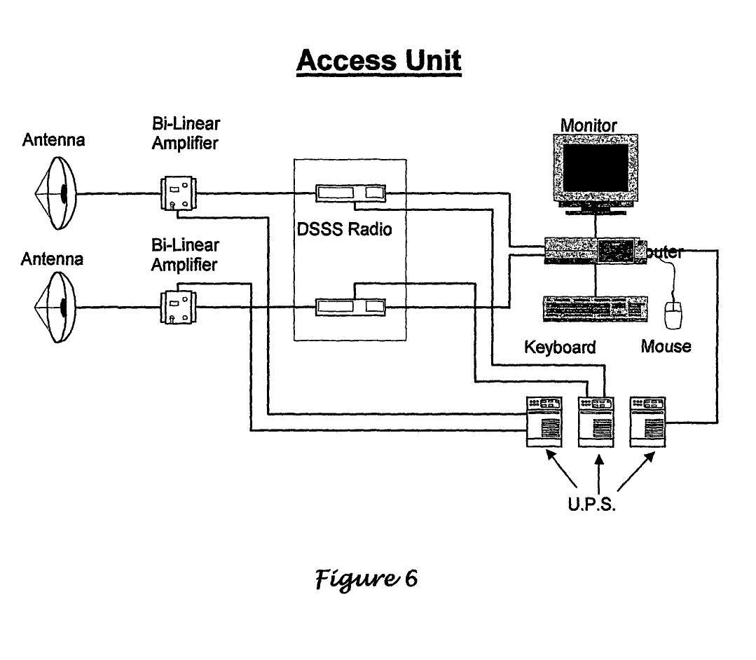

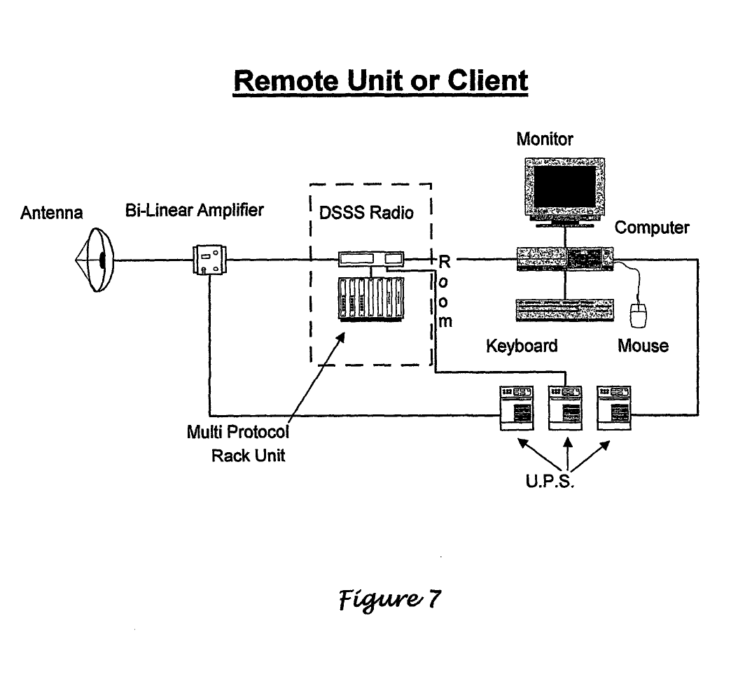

The hardware required for the wireless communication apparatus for the network in accordance with the invention is shown in FIGS. 3 to 5. In FIG. 5 there is shown a MUX unit having a wireless communication system for use on unlicensed frequency such as a Code Division Multi Access (CDMA) frequency. The system includes a first interfacing unit able to interface with a selected input from a plurality of different protocol inputs including voice and data inputs as selected at the first interfacing unit;

a multiplexer-for converting the various different protocols to one or more predetermined transmission protocol. A router is used and connected via a hub for Ethernet connection and is for prioritizing inputs to determine the order of transmission according to a predetermined priority and system requirements. A radio converter in the form of a DSSS radio card is fed by the router and powered by the router or a separate power supply. This enables spread spectrum transmission of the routed signal over a set open multi access frequency, with the converter modifying the frequency spectrum of the data-signal to be transmitted by spreading the signal using a code uncorrelated with that signal. A radio transmitter is fed the coded signal and can include an amplifier for transmitting the spread spectrum data-signal.

The remainder of the system is a complementary radio receiver for receiving the transmitted data-signal, a complementary radio converter for converting the transmitted data-signal to the one or more selected transmission protocols and a multiplexer for converting the one or more selected transmission protocols to a selected protocol. A second interfacing unit is able to output a selected one of a plurality of different protocol outputs.

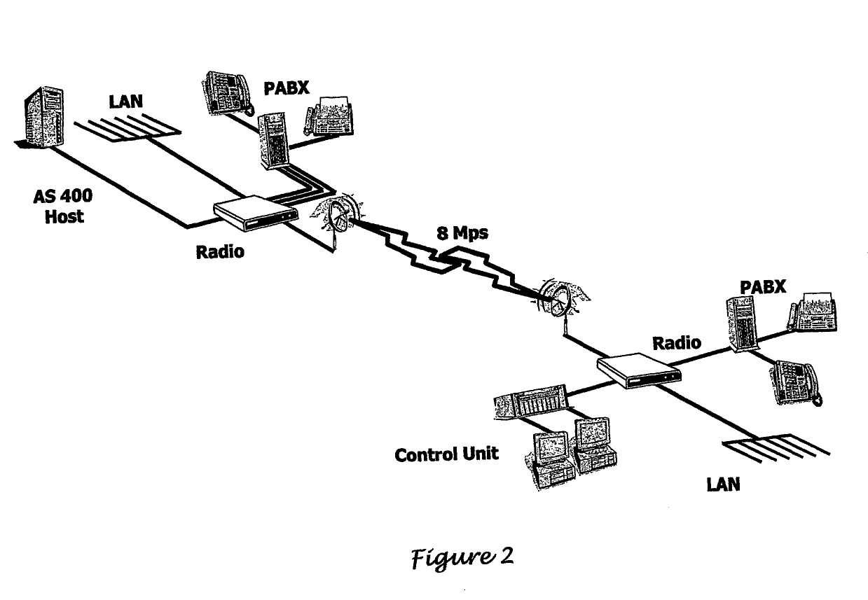

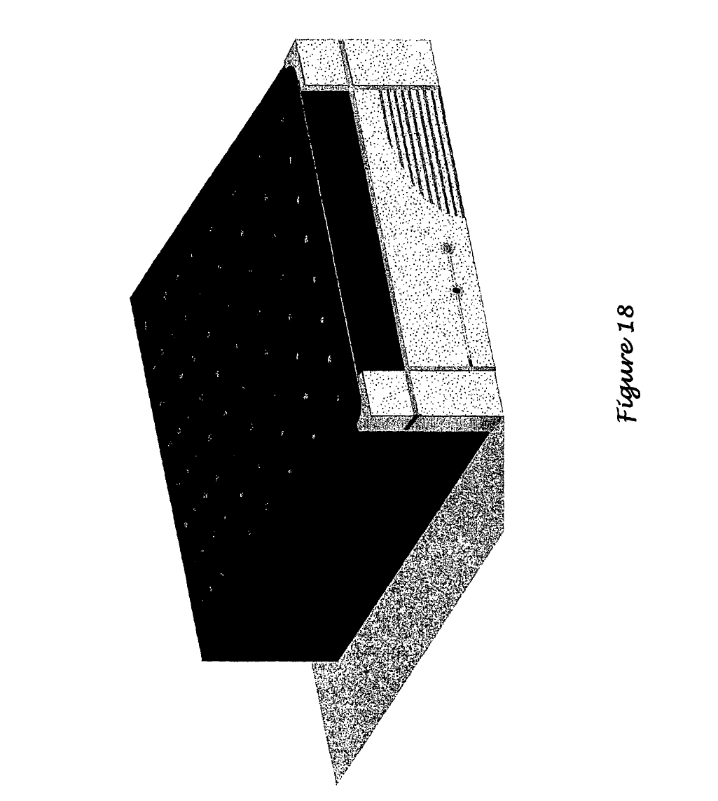

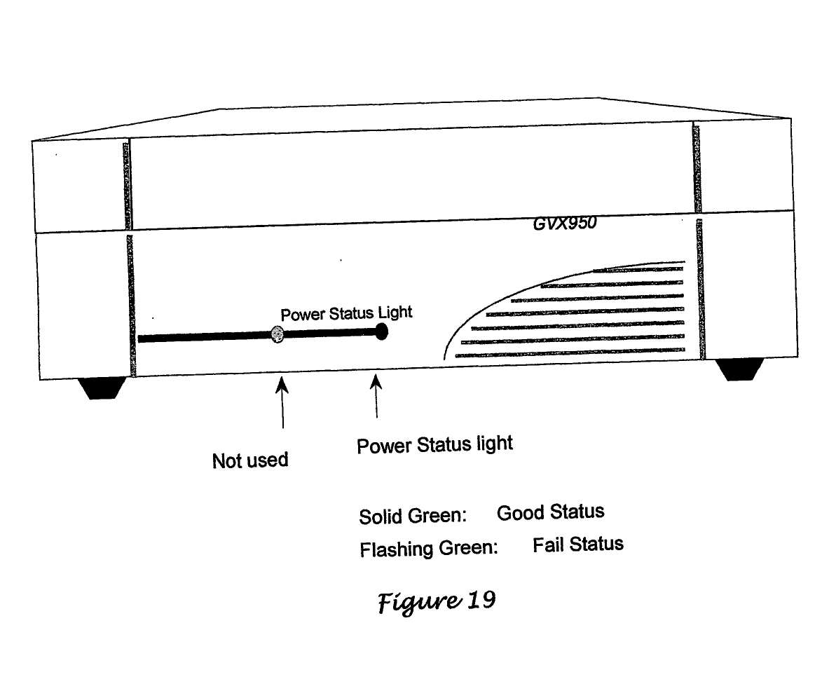

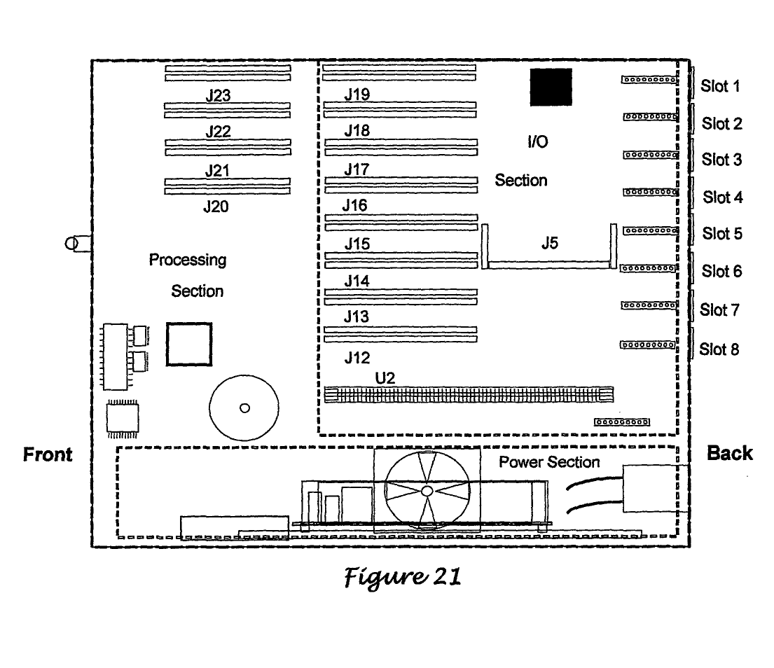

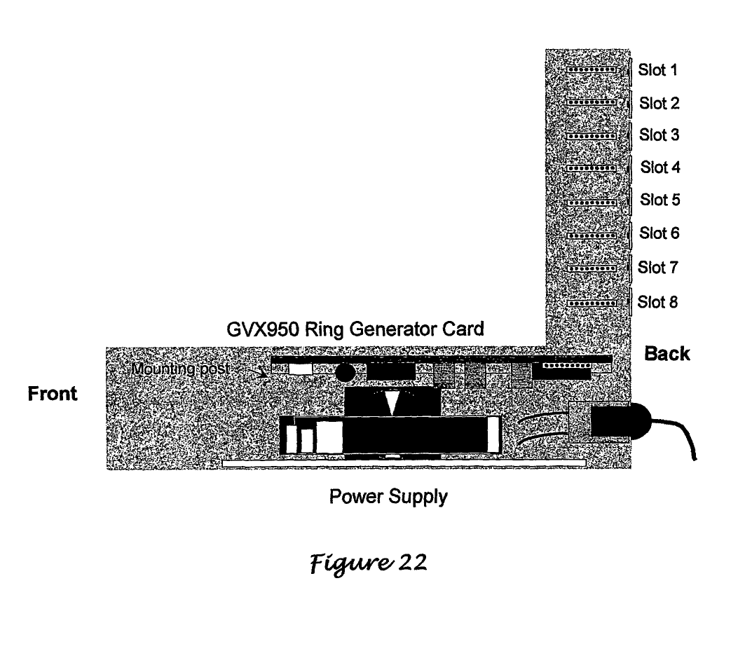

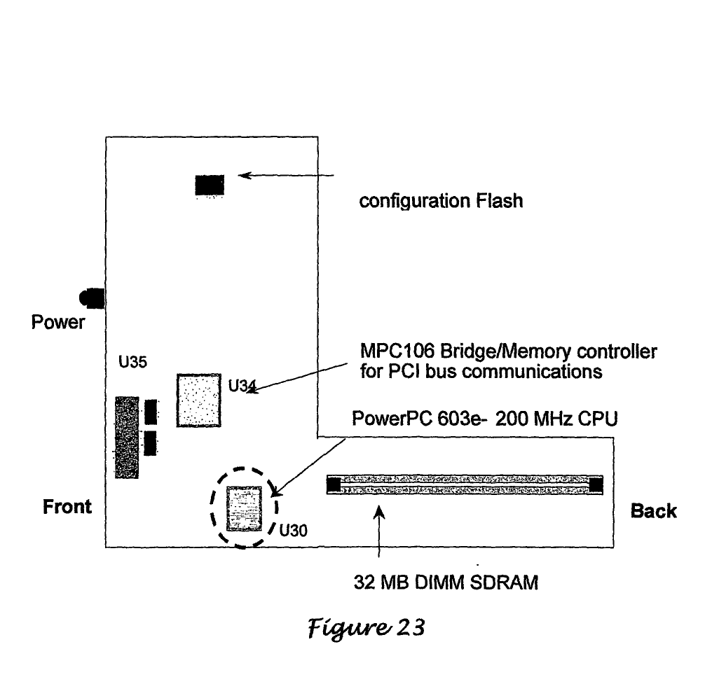

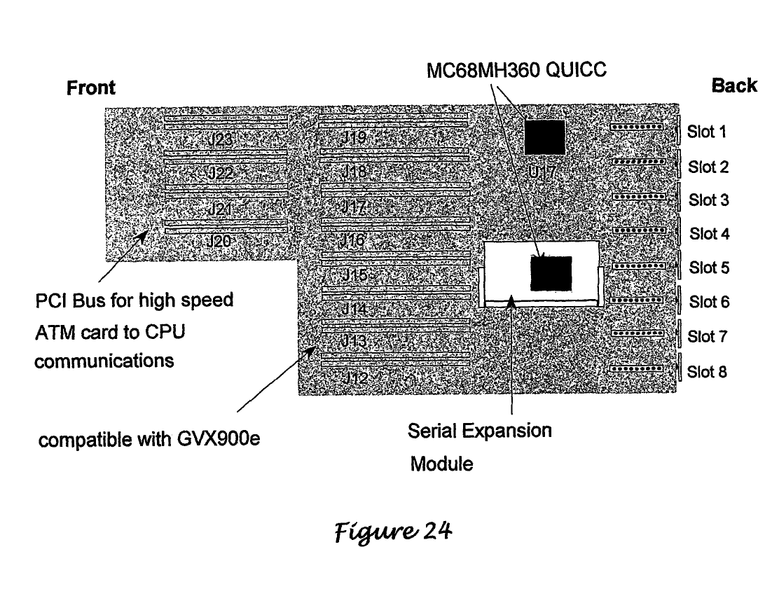

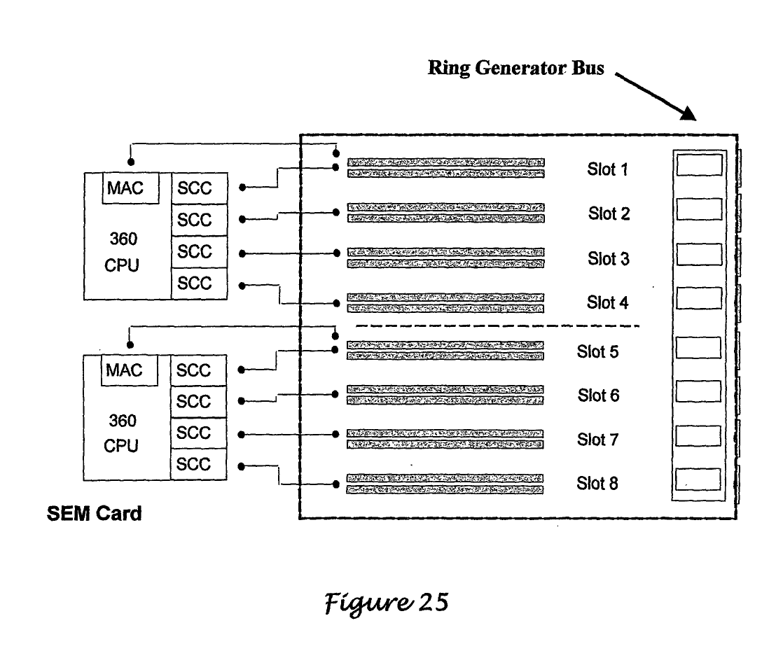

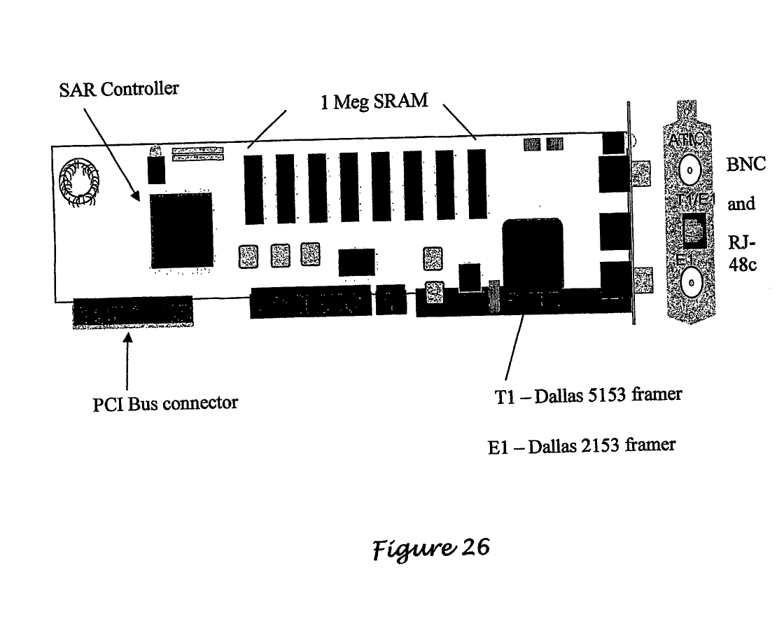

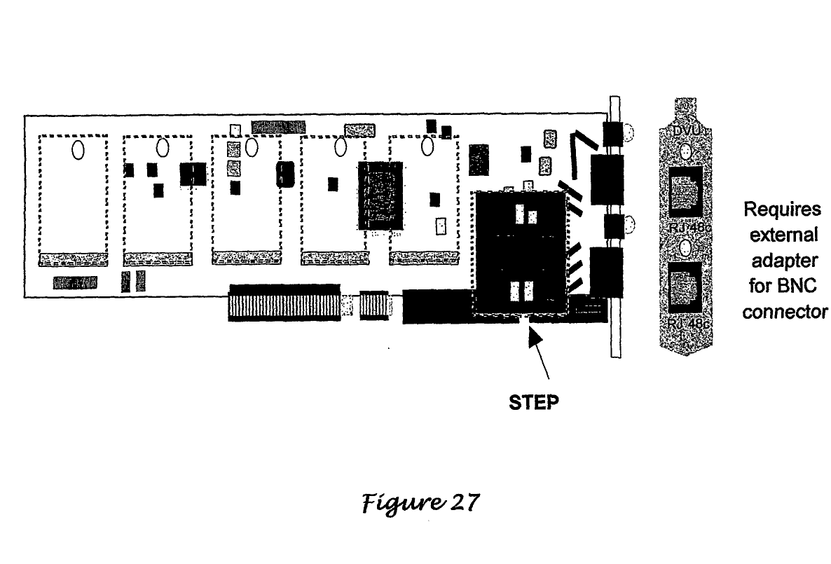

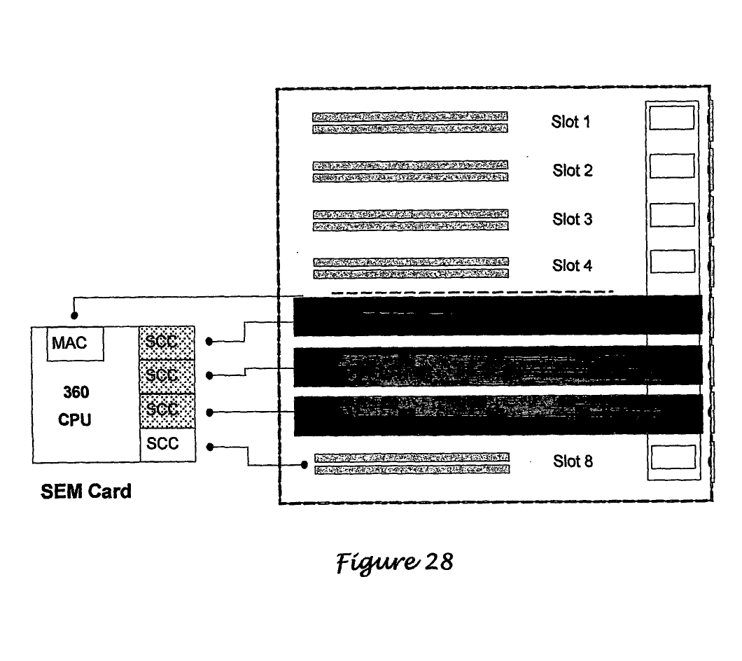

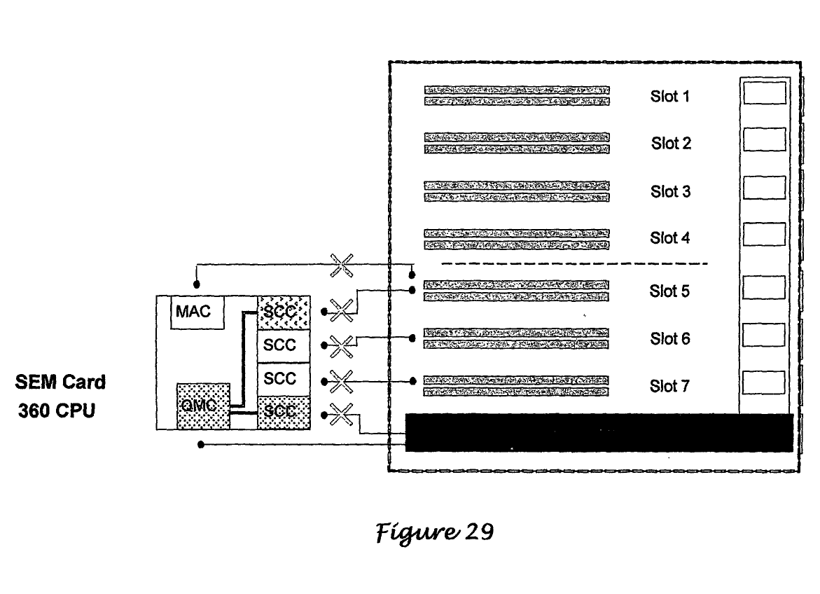

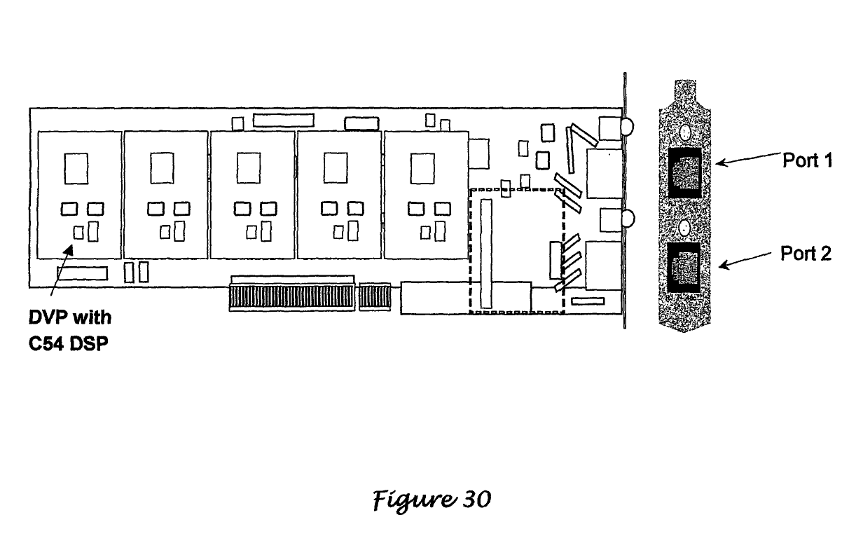

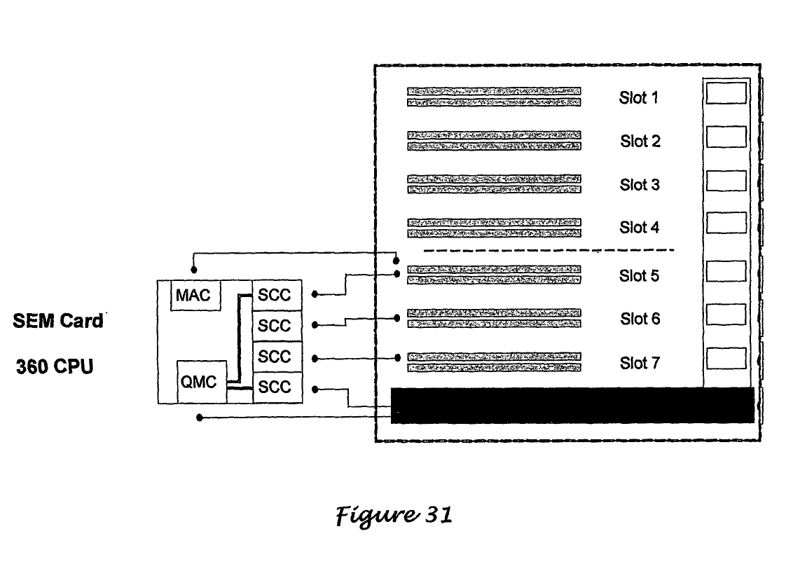

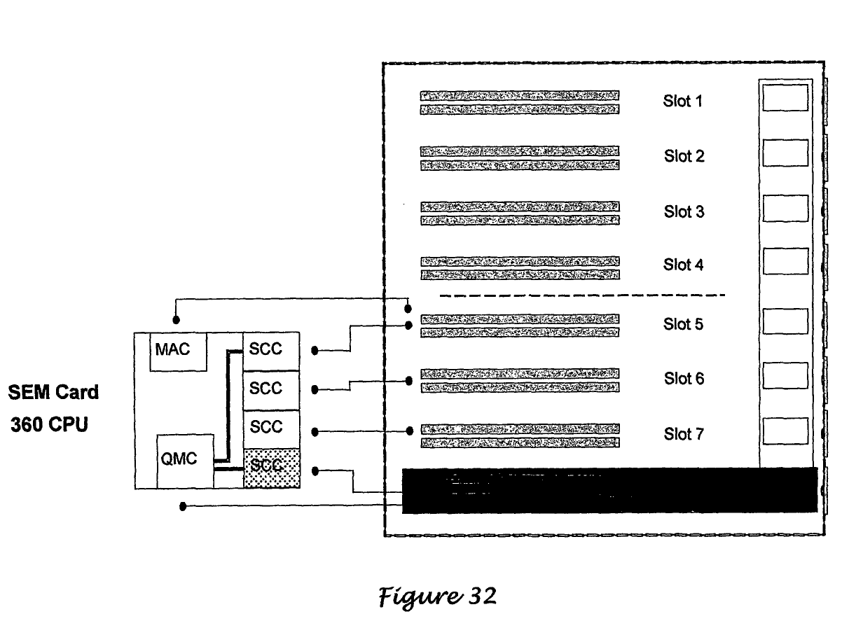

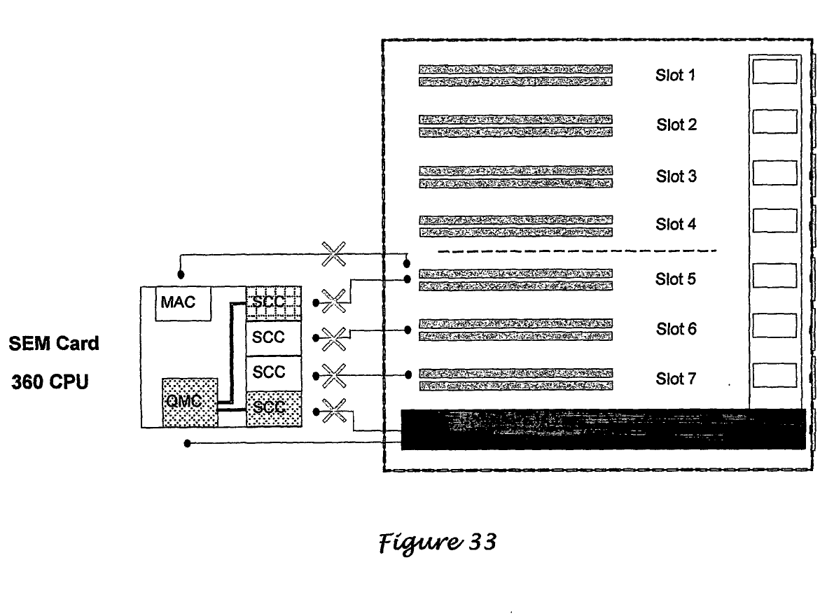

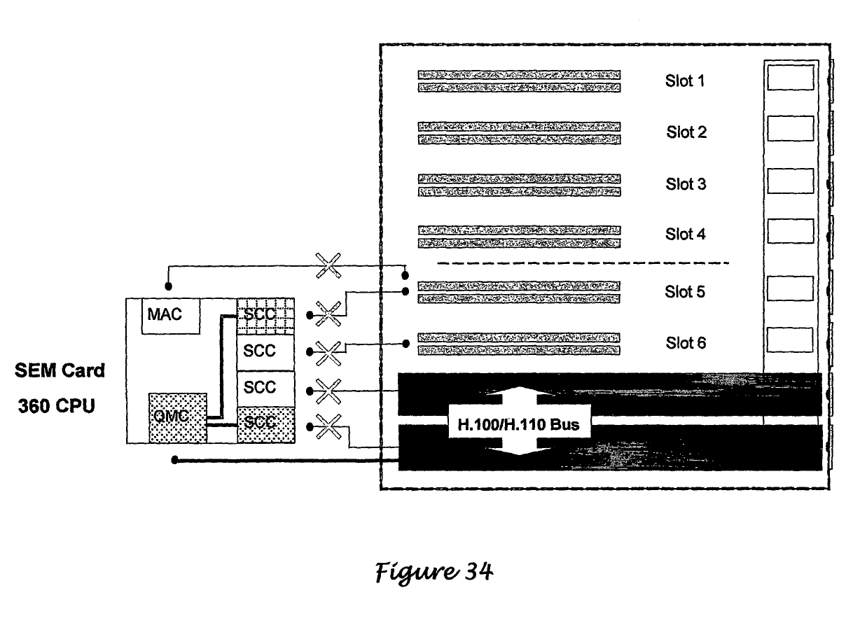

However clearly a single unit could be an input/output to act as relay for receiving any of a multiple protocol and sending out by radio or via other output in different protocol as required. Referring to FIGS. 18 to 34 there are shown diagrammatic views of the MUX unit of the wireless communication system apparatus as shown in FIG. 3 for use in the network of FIG. 2 in accordance with the invention. The GVX950 is a MUX unit that holds a number of communication card systems to allow multiple protocol communications interface systems and channels them thought the radio box GVRx000-xx.

Additional notes:

ATM T1/E1 access node

Digital Interface Module (DIM)

High performance Power PC 200 MHz CPU

Up to 8 I/O cards can be installed

Up to 36 data ports

Up to Analog 8 voice ports

Up to 30 Digital voice channels

supports Ethernet ports

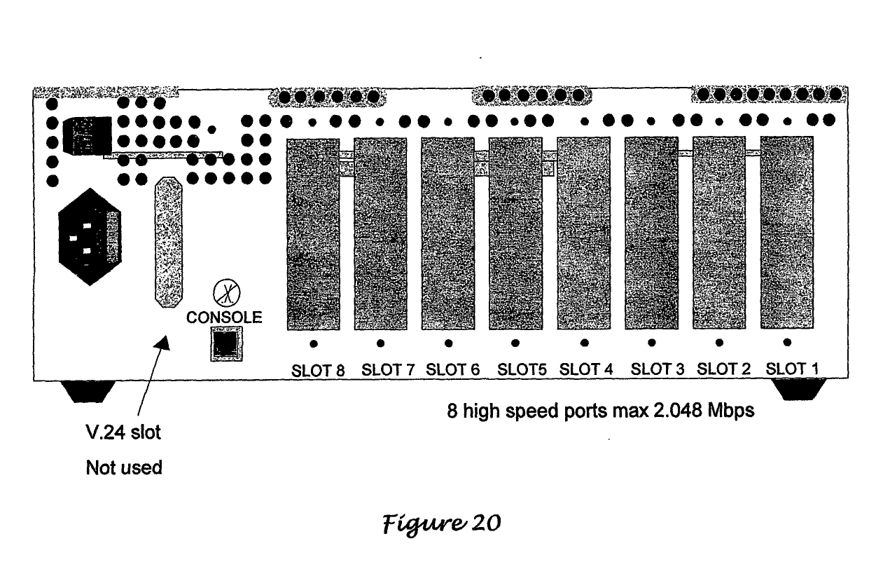

Referring to the FIGS. 18 to 34 in detail in FIG. 20 there is shown GVX950 Back View, where the GVX950 has 8 outlets for the card slots. It is very similar to the rear of a conventional desktop computer. It has an RJ45 connection labeled “CONSOLE” to allow programming access to the GVX950. It also has the power supply AC input and it may be switched between 90 to 264 VAC.

As shown in FIG. 5 the apparatus of the wireless communication system in accordance with the invention is able to input and output a multitude of protocols. In this embodiment this achieved by the GVX950 Interface Options

Serial V.35, V.24, X.21.

Analog voice—FXS, FXO, and E&M; 2-wire and 4-wire. Voice compression support: ACELP II (5.8 Kbps, 8 Kbps), G.726 ADPCM (16, 24, 32 & 40 Kbps), G.711 PCM (64 Kbps), and G.729 (8 Kbps) in Release 3.0.

Digital Voice—T1: digital, ISDN PRI, CAS—T1—up to 24 channels, E1: MFCR-2, R2, CAS—E1—up to 30 channels.

56K, 64K, T1, and E1 DSU.

ISDN BRI—S/T or U interface, data and voice.

V.34 modem.

Ethernet 10BaseT.

Fast Ethernet 100BaseTx.

Token Ring, STP and UTP.

T1 or E1 ATM interface.

GVX950 Motherboard:

The GVX950 system board can be divided into three main areas: processing, I/O, and power section. Each section is described in detail on the following pages.

Power Cord Options—the Power Cord Options Available Are:

North America—115 VAC/60 Hz, North American Plug, also used in Central America and parts of South America

Continental Europe—230 VAC/50 Hz, Schuko Plug/Europlug

United Kingdom/Ireland—230 VAC/50 Hz, British Plug

Power Supply Section:

The GVX950 comes with a universal-input DC power supply for easy AC power connection to any voltage source from 90 to 264 VAC. The unit comes with two built in cooling fans located next to the power supply.

GVX950 Ring Generator Card:

A ring generator card has been designed for the GVX950. The load supported will depend on the type of analog voice card installed. All analog voice cards require the Ring Generator card to be installed.

ACELP Analog Voice: 1.5 REN (ring equivalency number) per FXS port for a total of 10.5 REN (7-AV cards). The maximum loop distance is 2 Km.

G.729 Dual Analog Voice: Up to 2 REN per FXS port for a total of 16 REN (4-DAV cards).

The maximum loop distance is 1 Km.

Additional Notes:

Up to seven Analog Voice cards can be installed.

Up to four Dual Analog Voice cards can be installed, supporting eight voice ports in four slots.

Processor:

The Motorola Power PC-603 RISC processor provides for a major increase in performance compared to the earlier GVX products.

Memory

32 MB of SDRAM, located at U2, is installed by default. The application software and configuration is combined on the same 4 MB flash memory.

Software 2.9.0 does not support more than 16 MB.

Software 2.9.5 supports 16 or 32 MB.

Software 3.0 supports 32 or 64 MB.

A boot EPROM located in U35 is used on start up to perform system self tests and launch the application code.

GVX950 I/O Section:

The 10BaseT Ethernet cards can be installed in slots 1 and 5.

The PCI bus provides high speed access to the CPU and is used by the new ATM cards for quick access. Note the PCI bus does not use standard PCI connectors. In contrast, the Motorola bus uses a standard PCI (Peripheral Component Interconnector) connector.

A Motorola QUICC 360 processor, (located U17 on the motherboard) provides both SCC support for the various serial interface cards in slots 1-4, and a MAC for the 10BaseT Ethernet card in slot 1.

The SEM plug-in QUICC provides SCC support for serial I/O cards installed in slots 5-8, and/or the 10BaseT Ethernet I/O card in slot 5. Refer to the Ethernet I/O card section in Module 5 for more details.

Additional Notes:

SCC—Serial Communications Controller.

MAC—Media Access Controller.

SEM—Serial Expansion Module.

QUICC—Quad Universal Integrated Communication Controller.

GVX950 I/O Section comprises a Motorola 360 QUICC processor comes with an integrated MAC and four SCCs. The MAC is used to drive an Ethernet card installed in slot 1 or 5. The four SCCs are used to drive serial interface cards. A second 360 processor provided by the SEM is used to drive serial interface cards in slots 5 to 8.

Definition of Terms:

QUICC—Quad Integrated Communications Controller.

SCC—Serial Communications Controller.

MAC—Media Access Controller.

SEM—Serial Expansion Module.

The ATM I/O card is designed to provide ATM access to T1 or E1 services for the GVX950. All ATM processes are performed by hardware residing on this card. A different framer is used for either T1 or E1. The type of framer required must be specified when ordering since the framer cannot be changed in the field.

RJ-48c Interface

1—(+)Rx Tip T1

2—(−)Rx Ring R1

4—(+)Tx Tip T

5—(−)Tx Ring R

The ATM card cannot coexist with a Token Ring I/O module in the same chassis.

Impedance Settings

T1 RJ-48C 100□

E1 RJ-48C 120□

E1 BNC 75□

Digital Interface Module—Data Options. The DIM must be always be installed in Slot 8 therefore there is a maximum of one DIM card per GVX950 chassis.

An optional Secondary T1/E1 Processor (STEP) module can be inserted on the Digital Interface Module to support a second T1/E1 port.

The Digital Interface Module can be used for HDLC data, including Frame Relay.

The DIM is supported by all Rev. 3.0 software options when configured for data.

For BNC (E1) connections, an external adapter is available, RJ-45 to BNC, 1 metre cable.

One Dual BALUN adapter is required for each E1 port.

SEM Requirements for the DIM Card:

Each SCC on the 360 CPU can support up to 31 time slots for data (31×64 Kbps bandwidth) multiplexed into a single data channel.

Special Case:

Since SCC requirements for unchanneled data is limited to a single SCC up to three DIM I/O cards can be installed using this configuration. This is an expensive option since the T1/E1 DSU card performs the same function at a lower price.

Unchanneled configuration is limited to a single port. The STEP module cannot be used to provide a second port.

Definition of Terms:

SCC—Serial Communications Controller, provides support for unchanneled data.

SEM Requirements for the DIM Card:

The QMC on the 360 CPU can support up to 32 time slots for data (32×64 Kbps bandwidth) multiplexed into more than one data channel. In order to support channeled data or ISDN PRI data the QMC uses SCC number 1 and 4 in combination. This task consumes most of the memory resources of the 360 CPU and effectively disables the MAC and other SCCs. This requirement will place hardware limitations on I/O cards requiring SCC support in slots 5, 6, and 7.

Slots 1 to 4 are not affected by the DIM card in slot 8.

Definitions:

QMC—Quad Multichannel Controller, provides support for channeled data.

SCC—Serial Communications Controller, provides support for unchanneled data.

Digital Interface Module—Voice Options

Support for: T1/E1 CAS, CCS, ISDN PRI and QSIG PRI voice/data configurations. CCS and ISDN PRI applications require a SEM card to support the signaling channel.

DVP—Digital Voice Processor

The C54 DSP chip on each DVP contains two DSPs. Each DSP supports three digital voice channels, for six channels per DVP. The DVP is supported by Rev. 3.0 software options 2 and 3 only.

Note: The voice support uses C54 DSPs and therefore, when the DIM is used for voice, it cannot co-exists in the same chassis with C31 DSP based cards: the Analog Voice and DDVC (Dual Digital Voice Compression card).

SEM Requirements for the DIM Card:

Voice only applications using channel associated signaling will not require the resources of the SEM card since no data channel is configured.

SEM Requirements for the DIM Card:

A single ISDN PRI Voice only connection will require one SCC in order to support one signaling channel (D-Channel).

SEM Requirements for the DIM Card:

Two ISDN PRI voice only connections will require the QMC in order to support two signaling channels (D-Channel).

GVX960 DIM Card Support:

Two DIM cards can be installed in the GVX960 to support up to 60 voice channels and up to 32 time slots for data. Access to the QMC from slot 7 through slot 8 is provided using H.100/H.110 bus implementation across the I/O connectors.

Both DIM cards can be used with or without a STEP to provide from 2 to 4 T1 or E1 connections.

Definitions:

H.100/H.110: ITU-T recommendation for a computer bus interface for video and telephony systems.

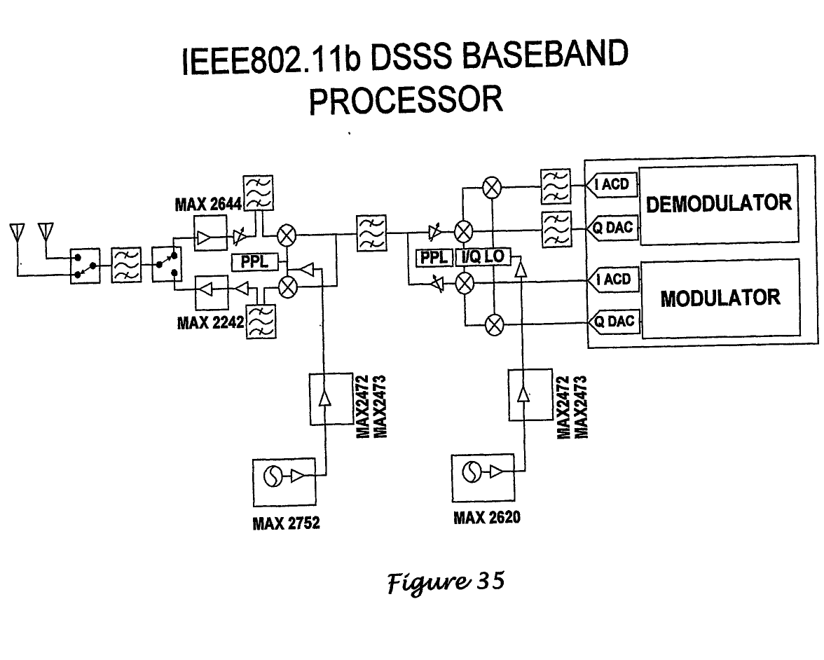

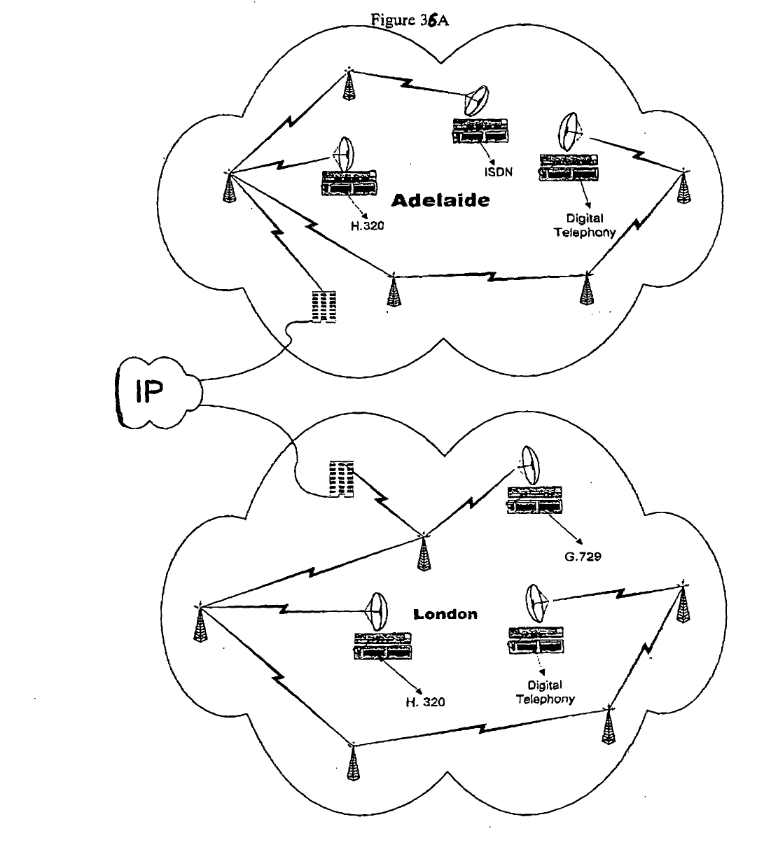

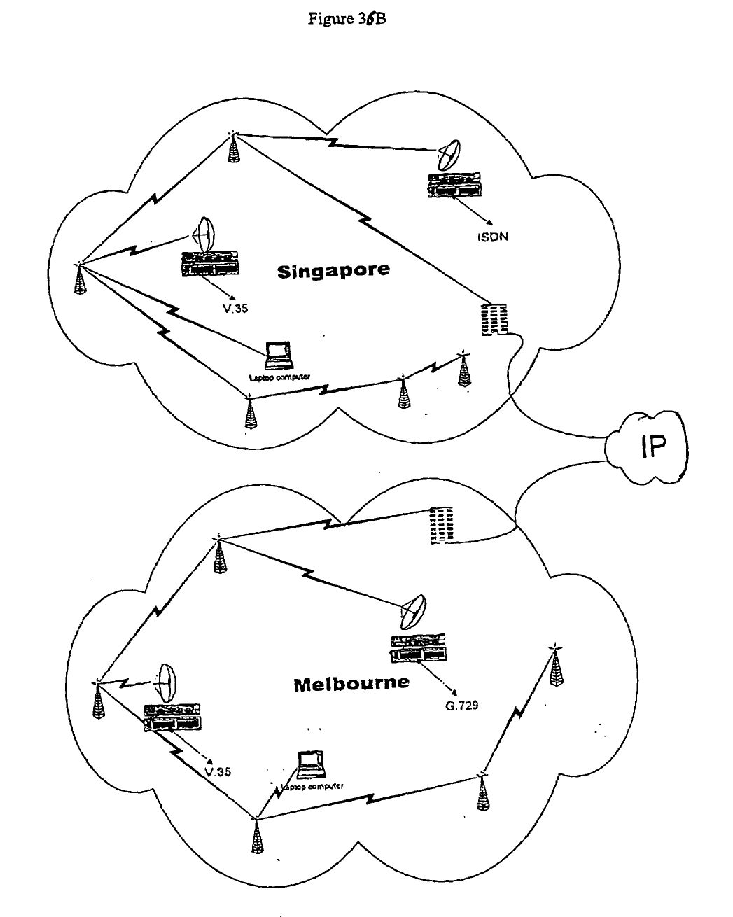

Referring to FIG. 35 there is shown is a diagrammatic view of the transceiver unit of the wireless communication system apparatus as shown in FIG. 3 for use in the network of FIG. 2 in accordance with the invention. This is a block diagram for 2.4 GHz IEEE802.11b DSSS WLAN transceiver application

By using the Maxim MAX2242 linear PA and the MAX2752 VCO this design is able to use minimal space on a printed circuit board allowing the expansion of the performance, such as receiver sensitivity and variable power outputs. By placing certain components, such as oscillators, in an area on the printed circuit board where they will not interfere with the receiver circuit (due to some of the noise that it can generate), this design can rapidly decrease noise. The radio alone may achieve output power of +22.5 dBm at 2450 MHz. The receiver at the front end has an ultra low noise amplifier with a high gain of 17 dB. Sensitivity of the receiver is measured at

Without the ultra low noise amplifier, the receiver may achieve signals at −114 dBm.

For the linear power amplifier at 2.45 GHz, the MAX2242 provides +22.5 dBm of linear output power, 28.5 dB of gain from a 3.3V supply, while offering 33 dBc ACPR performance, exceeding the IEEE802.11b standard by 3 dB. It incorporates an adjustable bias control to allow throttle back of supply current at lower power levels, an on-chip power detector, and a 0.5 μA shutdown mode to extend battery life. The MAX2242 is offered in the ultra-hip-scale package (UCSP) configuration and measures 1.5 mm×2.0 mm.

The RP Voltage-Controlled Oscillator is achieved by the MAX2752 VCO incorporating factory-trimmed tank-circuit components and varactors into a single 8-pin μMAX package, greatly reducing board space and design time. The MAX2752 tunes over the 2025 MHz to 2165 MHz frequency range, delivers −3 dBm of output power, and offers phase-noise performance of −125 dBc/Hz at a 4 MHz offset.

For the IF Voltage-Controlled Oscillator, a popular chipset requires an IF LO of 374 MHz to down-convert the IF signal to baseband. This IF LO is achieved by dividing the external VCO frequency with an internal divide-by-two circuit. This IF LO can be realized using the MAX2620. The MAX2620 is a VCO that requires an external tank and varactor, allowing it to be tuned to the required 748 MHz.

Network

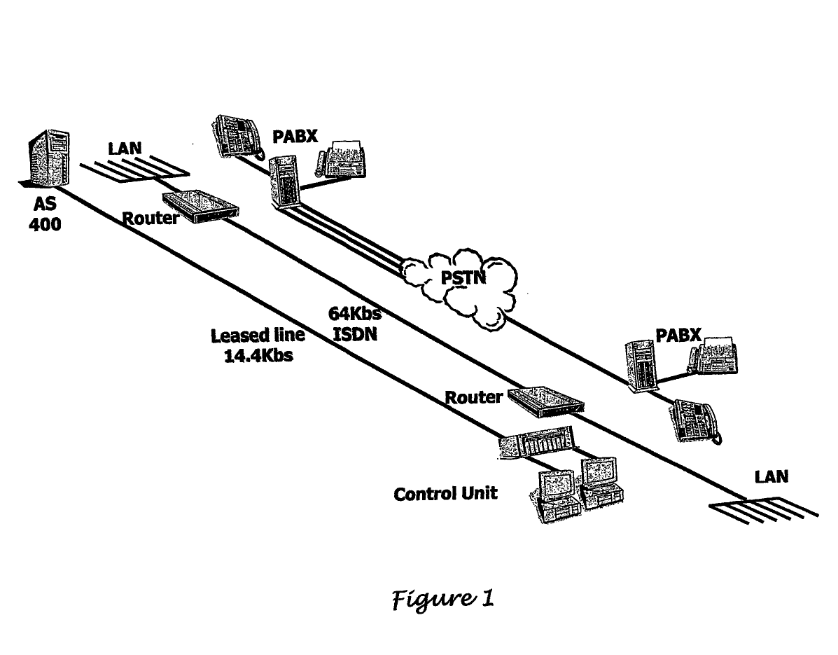

FIG. 1 demonstrates a typical, conventional network that is not integrated. An AS 400 system is utilising a leased line at 14.4 Kbps. The LAN network is using a router and an ISDN line at 64 Kbps. Finally, the telephone system (PABX) is using the local PSTN network. It also can be noticed that the bandwidth utilised is limited.

FIG. 2 demonstrates the same network that is linked and integrated by the wireless communication system at greater bandwidth, for example, 11 Mbps. In this case, it is using two antennas to air interface the link. This process eliminates the need for leasing numerous lines and the additional hardware boxes.

FIG. 3

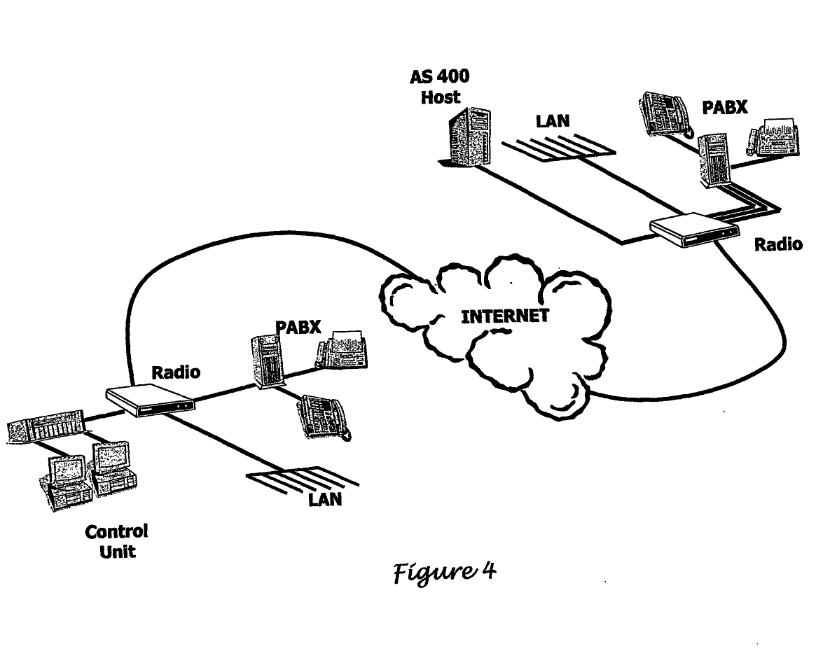

FIG. 4 demonstrates the displayed network using the wireless communication system to integrate and link the network via the Internet or leased lines if required.

The system is a cost effective way to distribute Internet access as once a wireless network is set up, it requires only a high-speed access to one central location within the network system (i.e.: star topology theory). There is only a monthly access fee without telephony call charges. The system supplements existing wired communication networks. In many countries, including the United States and Australia, there are large populations including small office workers, living in areas too remote for fast wired-line access to the Internet. It is not cost effective for cable television providers to dig trenches or employ microwave links to offer fast communication services. Telephone companies see too little customer density to warrant installing digital subscriber services. The wireless communication system is ideal in such situations.

In developed countries, the system acts as a new local exchange carrier with a radio link that supports analogue voice telephony acts as a simple local loop between a user and a telephone company's central office. It becomes an effective tool to compete with local exchange carriers. In developing countries with little or no telephone infrastructure, the wireless communication system can provide a telecommunication infrastructure with minimal initial investment. It is estimated that by the year 2003, over half the new fixed phone lines installed worldwide each year will be wireless.

In addition, the system provides an effective means to access broadband communication. Far fewer subscribers, both in business and apartment buildings, have access to fibre for broadband communications. Fibre penetration to commercial buildings and multiple dwelling units is at best 3%, noted Thomas Cheetah, president and chief executive of HeliOss Communications Inc., Waltham, Mass. The only solution, in his opinion, is through fixed wireless, this can support channel capacities of 155 Mbps and above.

The system allows establishment of private corporate networks such as for large business customers and multiple dwelling units at airports, hospitals, and universities. Each can use the wireless communication system to provide a broadband wireless connection by way of a private branch network at the customer premises. The local carrier would then provide the gateway to the public switched telephone network (PSTN).

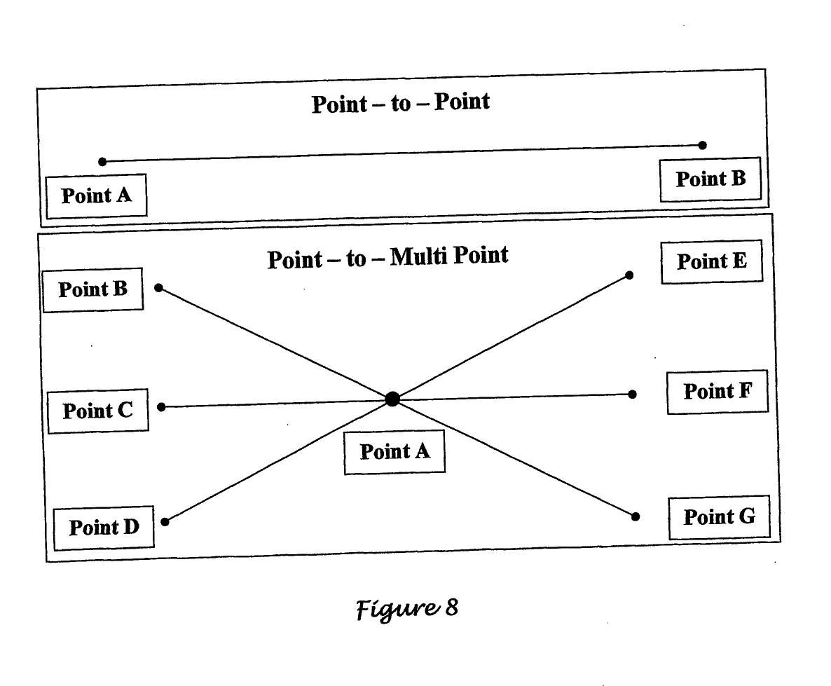

An example of point to point and point to multipoint is shown in FIG. 8. At the customer site, the wireless communication system serves as the end in a star-topology or a point-to-point network. The unit consists of a proprietary protocol computer connected LAN/WAN card and a radio connected to a rooftop or an intra-building antenna. The customer's LAN/WAN is cabled to our company's the wireless communication system. Data is routed from the customer's router, through the radio, and across a wireless link to the other wireless communication system located at the base site.

At the base site, the wireless communication system serves as the central collection point in a star-topology network or the near-end/far-end for a point-to-point network. The wireless communication system forwards traffic between dispersed remote units and to networks such as the Internet.

The system provides a replacement for conventional cable lines and microwave transmission systems. The enormous cost advantage and high transmission capacity have made radio links increasingly popular as a provider to Internet Service Providers (ISP). In addition, the wireless communication system software is able to prioritise voice over data. This enables the system to keep its latency time under tight control and provide good voice communication through the Internet. Essentially, the user's computer would digitise the voice and set up a Point B, Point C, Point D, Point E, Point F, Point G, Point A Point-to-Multi Point Point A Point B Point-to-Point.

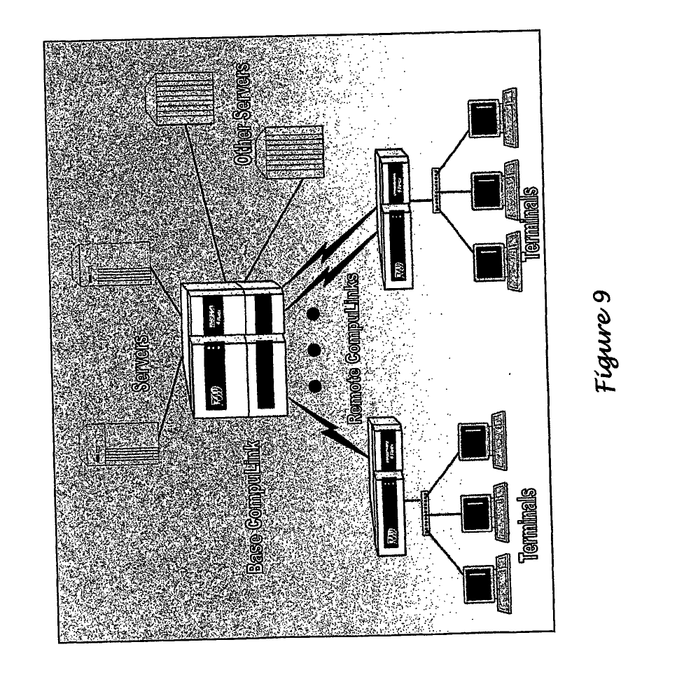

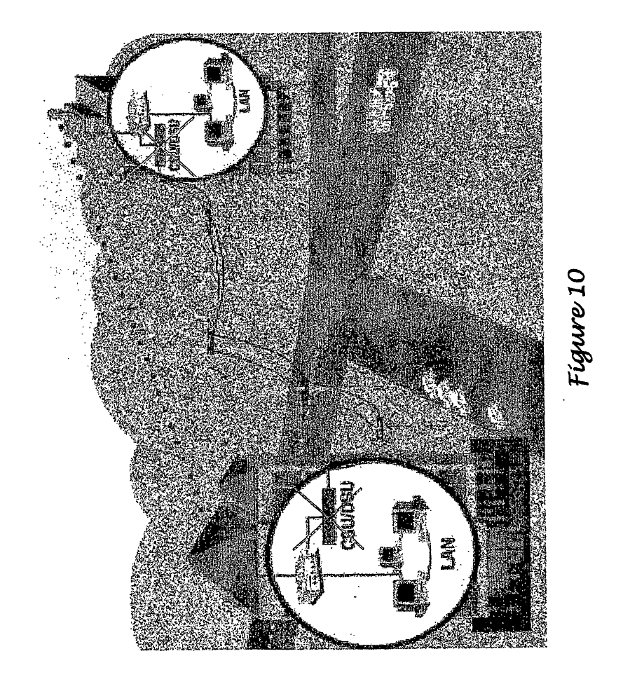

FIG. 9 demonstrates Branch Office Networking made easy using the wireless communication system). FIG. 10 shows how the system can replace an existing leased line. Other wireless linkage may include connection of PC workstations to host computers and/or servers; connection of PC terminals to host computers; linking remote LANs to the corporate LAN bypassing commercial telecommunications provider networks; hostile environment for the wiring of LANs/WANs or even temporary LANs/WANs; and routing between Novell servers (IP/IPX) and Windows NT servers (IP).

Internet protocol address with the provider. Communication between the user and the ISP would be implemented in a packetised manner. At the provider's facility, the packetised signals would be converted into conventional analogue phone signals and fed to the public switched telephone network (PSTN).

The system provides a systematic design procedure for establishing Virtual Private Networks and provide a variety of methods to accommodate different customer requirements. Virtual Private Networks (VPN) provides corporations with constant access between two or more premises through the Internet cloud. A VPN can extend worldwide. The security of the network is always protected by encryption (the process of converting a message into computer gibberish and then decrypting it at the destination point). A VPN can be defined as follows: An encrypted or encapsulated communication process that transfers data from one point to another point securely [over the Internet]; the security of that data is assured by robust encryption technology, and the data that flows passes through an open, unsecured, routed network 1.

Large Telco's and small ISP's can provide VPNs. The amount of bandwidth accessible will depend on who provides the link and the price range of the customer. VPNs require a DAL (Dedicated Access Line), either of copper or fibre optics that goes straight to the ISP and connects to the Internet. Bandwidth and true throughput will be dependent on which medium is chosen.

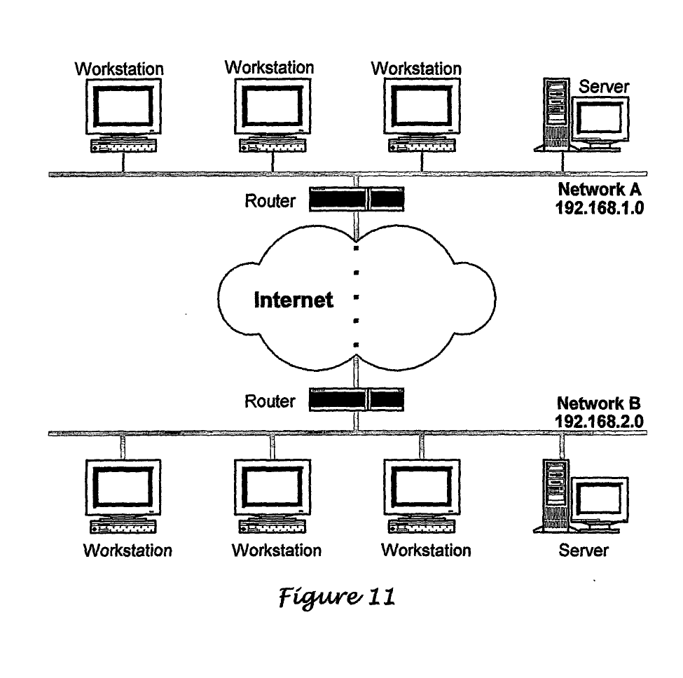

FIG. 11 shows a VPN connected to the Internet through a traditional wired infrastructure. One of the main benefits of Virtual Private Networking is minimising cost. The most prominent cost is long distance phone charges. Utilising the Internet cloud removes the need to access the Telco's conventional wired infrastructure and enables cost-effective international communication. There are savings made on local telecommunication charges as well as on leased lines. There are administration overhead savings and the elimination of some dial-up remote access equipment. Ease of maintenance and simplified network management also eliminates some cost.

“Virtual” is a term used to describe private networking of today. “virtual” because the Internet is utilised to create the network. The wireless communication system wireless technology can create private networks that are “virtual” and “non-virtual”. These terms relate to various applications of the wireless communication system wireless technology.

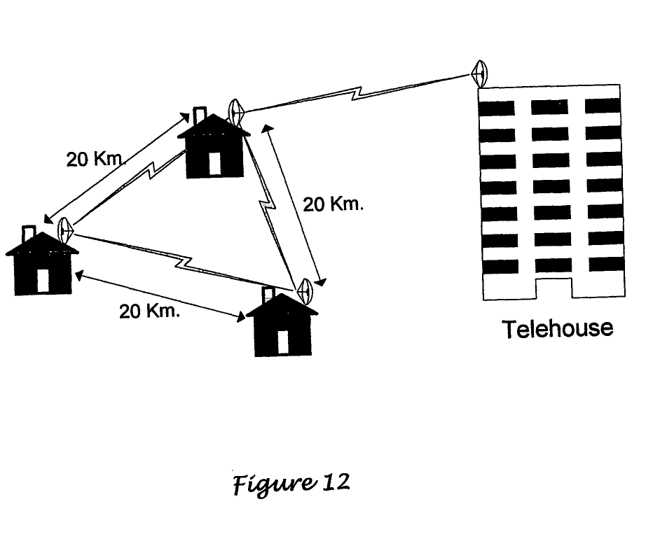

To use the wireless communication system for VPN the system as shown in FIGS. 12 to 17 uses:

_{.}Wireless Dedicated Private Networks (WDPN) creates a dedicated wireless link between two or more customers and is monitored from a Telehouse.

Wireless Dedicated Virtual Private Networks (WDVPN) creates a dedicated wireless link to a Telehouse or ISP that is networked through the Internet.

Wireless Virtual Private Networks (WVPN) forms a network through cellular style infrastructure (WLI) that is linked to a Telehouse and networked through the Internet.

_{.}^{˜}Wireless Private Networks (WPN) occurs between users within the coverage area of the Wireless Loop Infrastructure (WLN).

These design variations expand on the original definition of VPN and aim to maximise the potential of the wireless communication system wireless technology.

In Wireless Dedicated Private Network (WDPN), the term “dedicated” is used when a link transmits from user to user without going through Wireless Loop Infrastructure. WDPN is “non-virtual” because access is not required to the Internet to support the link. This method creates a WDPN within a local area and up to 20 km between two or more users. WDPN is achieved by using small wireless communication system boxes at each customer site. Each box has the capacity of delivering up to 11 Mbps bandwidth, uncompressed. Due to the large bandwidth available, the wireless communication system unit provides fast transmission speeds and has greater capacity for data influx compared with traditional leased lines.

The units are air interfaced, forming a secure private network without the need for Internet or costly leased lines. A Telehouse will constantly monitor the WDPN though air interface for maintenance, billing, and traffic monitoring. The Telehouse link will also provide the customer with optional Internet access, telephone call termination, or dial-up VPN.

Dial-up VPN will be a feature of the Wireless Loop Infrastructure (WLI). It will enable customers to dial another VPN from their VPN within the Infrastructure. A business will first need to allow themselves to be accessed by “outsides”. The “outsider” wanting to access the business would need to look up the IP address of that business and present identification to be allowed into Private Network. Additional software security methods will also be used to secure this process.

WDPN and The wireless communication system technology allow customer's constant voice, video and data transmission to each end user at a rapid rate with security, comfort and at minimal expense. This design is suitable for residential and small business applications. Builders may require VPNs with Architects and Suppliers who are all at different locations. The wireless communication system's WDPN would provide the bandwidth to transfer building plans, purchase orders, time schedules, databases, etc.

Wireless Dedicated Virtual Private Networks (WDVPN) differs from WDPN as they utilise the Internet for communicating, that is, they are “Virtual”. This method connects point to point, or point to multi point topologies via air interface from the end user to a Telehouse gateway, which allows customers to access the Internet and provides the ability to VPN worldwide. It is desired that the Telehouse gateway will have at least 100 Mbps access to the Internet, providing customers with the bandwidth to support their The wireless communication system unit.

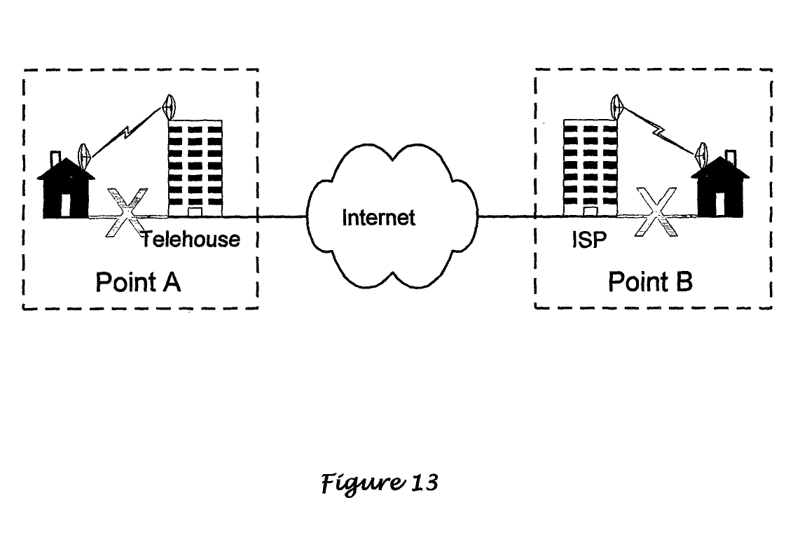

FIG. 13 shows that this link is “dedicated” because the end user communicates directly to the Telehouse and the link does not bypass through Infrastructure, as it will in the following methods discussed. This method allows ‘Point A’ and ‘Point B’ to be located anywhere in the world. At ‘Point A’, the end user is connected to the Telehouse gateway, although the receiving end need not have a Telehouse gateway. ‘Point B’ can communicate to any ISP in their location, being interstate or overseas. Of course, once the system expands interstate and overseas, there will be Telehouse gateways in other locations.

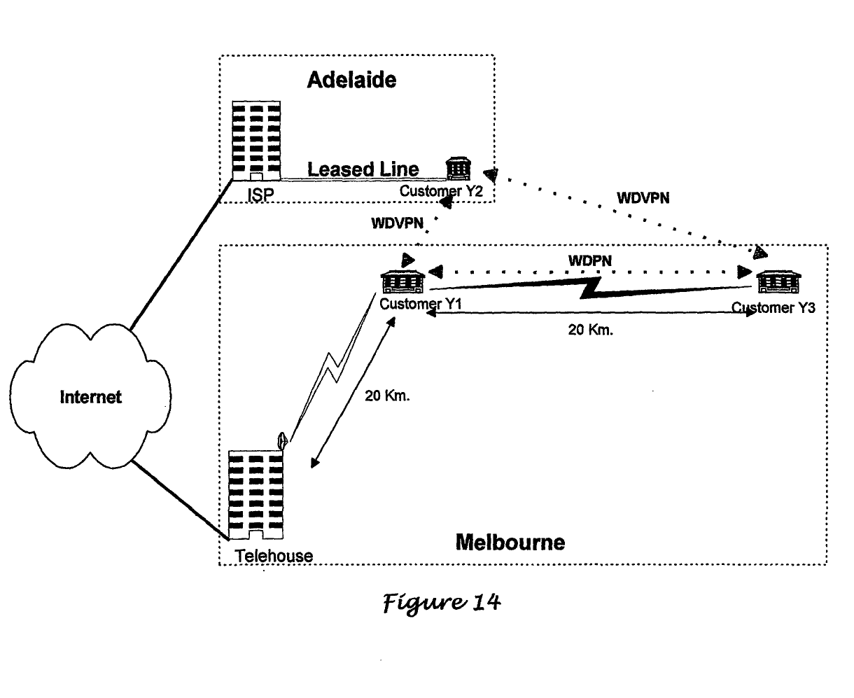

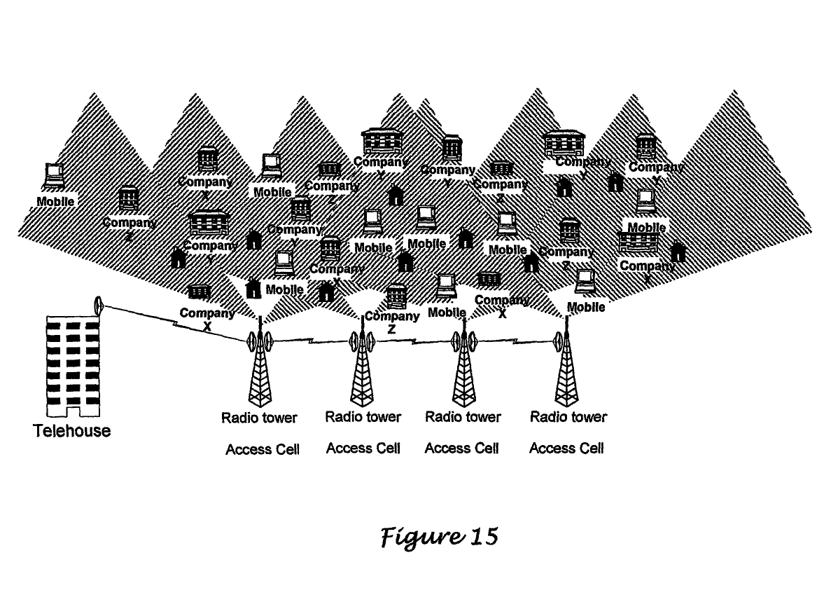

Applications range to support local businesses and domestic customers to large corporations needing interstate and overseas VPNs. FIG. 14 shows Networking between “Customer Y” and its various branch offices. “Customer Y 1” has a WDVPN with “Customer Y 2”. “Customer Y 2” communicates to the local ISP via conventional leased lines although they too can replace this with wireless technology. “Customer Y 1” and “Customer Y 3” utilise a WDPN. The link between “Customer Y 3” and “Customer Y 1” is a WDVPN.

FIG. 14 demonstrates how networks can expand by combining WDPN and WDVPN whilst the Wireless Loop Infrastructure (WLI) is being established. The design procedure so far has introduced WDPN and WDVPN. These networks do not require the support of backbone infrastructure to function, therefore, the networks are “dedicated”, and they can be implemented as soon as a Telehouse has been established.

Wireless Virtual Private Network (WVPN) and Wireless Private Network (WPN) are two ways in which Private Networks can be implemented once a Wireless Loop Infrastructure (WLI) has been established. Wireless Virtual Private Networking and Wireless Private Networking will operate simultaneously. Wireless Virtual Private Networks (WVPN) form Private Networks through the WLI that are linked to a Telehouse and networked through the Internet. Wireless Private Networks (WPN) occurs between users within the coverage area of the Wireless Loop Infrastructure without the need to utilise the Internet. Relaying the radio signal off the access cells to the intended destination creates the WPN. These two methods are not considered “dedicated” as the access cells in the Infrastructure are accessed by may users.

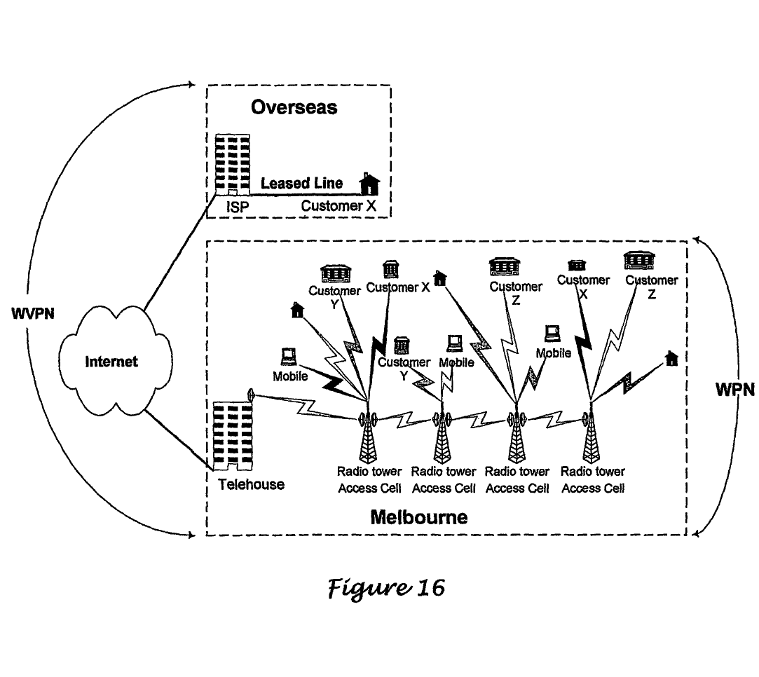

FIG. 15 shows the Wireless Loop Infrastructure can consist of one or more towers that blankets an area Any number of customers within the coverage area can access these towers. FIG. 11 shows the broadcast method of the access cells that blankets an area. The Infrastructure coverage area will depend on the number of access cells in the Network. One tower can blanket a diameter of 5 km. WLI can extend usage over greater distances by relaying the radio signal from the end user, off the access cell, through the WLI, to the Telehouse and through the Internet to the intended destination.

FIG. 16 shows how the two concepts can work simultaneously. Customers in a city such as Melbourne access their WPN through the access cells. The communication routes of three different organisations are shown. “Customer Y”, can access their WPN at a number of offices, a house and a mobile unit. “Customer X”, wishes to form a WVPN with their office overseas. They have a WPN in Melbourne but there is no wireless communication system Network Infrastructure at the destination point. Through the Internet, “Customer X” is able to form a WVPN that is secured by leased lines at the destination point (alternatively could be secured by air interface). Dial-up VPN is a term mentioned previously. In the above situation, it will enable “Customer Y” to dial into “Customer X” through a secure procedure. By establishing a Network Infrastructure, the system of WVPN/WPN can be mobile. When Network Infrastructure towers blanket a town or city, WVPN/WPNs can continue operating through the access cells on a mobile basis. The Private Networks always remain secure with the protection of encryption, codes and passwords. Security can be added with the use of a firewall that provides protection from attackers using port filtering, address translation, and inspection technologies.

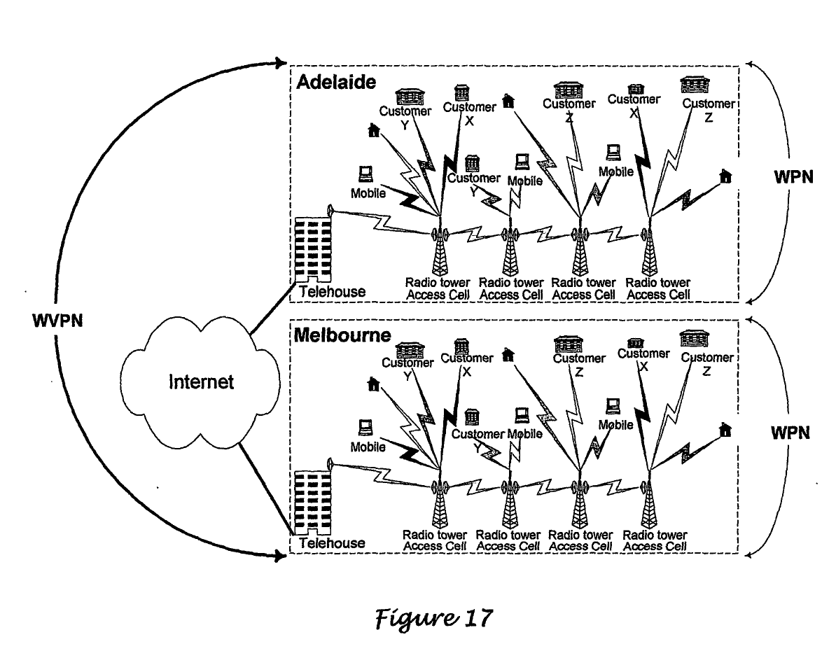

FIG. 17 demonstrates how two Wireless Loop Infrastructures are linked through the Internet allowing customers to form a WVPN whilst operating their WPNs. This network is achievable when Telehouse Gateways are established in the two (or more) intended cities. This design maximises the potential of the technology, allowing it to truly revolutionise communications.

Virtual Private Networks utilise the Internet to allow communication between each user in the network providing a high level of security as well as being a very cost-effective means of networking premises, which might otherwise spend excessive amounts on telephony fees. The wireless communication system wireless technology adapts this concept further by providing alternative methods to form Private Networks in “Virtual” and “Non-Virtual” ways. Bypassing costly leased lines by air interfacing, while at the same time providing large amount of bandwidth for constant video, voice and data transmission, the wireless communication system wireless technology revolutionises local and long distance communications. The implementation of the wireless communication system wireless technology can be progressive and aim to accommodate the needs of all types organisations whilst the Wireless Loop Infrastructure is established in designated cities.

The Telehouse gateway will need to be established first in order to provide the monitoring and billing services to each customer. The Telehouse gateway will have minimum 100 Mbps to 1 Gbps access to the Internet.

Two design variations can be implemented without the need for backbone support; (i) Wireless and (ii) Dedicated Private Networks (WDPN) and Wireless Dedicated Virtual Private Networks (WDVPN).

The former is ideal for customers with local branch offices and residences in close range (ideally 20 km) and that later is ideal for interstate or overseas communication. These variations are called “dedicated” which distinguishes them from the “shared” links that are used in WLI networking. Both variations will provide the customer with high bandwidth capacity and the ability to constantly transmit voice, video and data with each end user of the WDPN or WDVPN. These Networks are dedicated between users but they also have the ability to allow “outsiders” into their networks through mediums such as the Internet.

After establishment of one or more access cells in any given city, there are two other design variations, which will provide Private Networking to customers. The WLI will provide greater user coverage than the “dedicated” links. A Wireless Virtual Private Network (WVPN) will form a network utilising the access cells to repeat the signal to through the WLI, through the Internet and to the intended destination.

Alternatively, the WLI will provide Wireless Private Networks (WPN) within the coverage area, without the need to utilise the Internet for long distance communication.

Both variations function simultaneously. In the case of access cell coverage, more towers will be implemented progressively until the population density is blanketed. One of the major advantageous of the WLI is that it provides mobility through the access cells. This means that customers may log onto a WVPN or WPN through a portable computer equipped with a portable the wireless communication system. The wireless communication system wireless technology has the ability to transform Virtual Private Networks into a cost-effective solution for customers of all requirements.

Another variation can be to use Blue Tooth™ technology between the apparatus of the wireless communication system in accordance with the invention and other computers in an office or other input/output terminals.

It should be understood that this invention is not limited to the particular embodiments described by way of illustration but includes variations as understood by a skilled person in the art without the need for any inventiveness and such is included within the scope of this invention.

1. A wireless communication system apparatus for use on unlicensed frequency such as a Code Division Multi Access (CDMA) frequency, the system apparatus including:
a first interfacing unit able to interface with a selected input from a plurality of different protocol inputs including voice and data inputs as selected at the first interfacing unit;
a multiplexer for converting the various different protocols to one or more predetermined transmission protocols;
a router for prioritizing inputs to determine the order of transmission according to a predetermined priority and system requirements including video and voice being transmitted prior to data;
a radio converter enabling spread spectrum transmission over a set open multi access frequency, with the converter modifying the frequency spectrum of the data-signal to be transmitted by spreading the signal using a code uncorrelated with that signal;
a radio transmitter for transmitting the spread spectrum data-signal;
a complementary radio receiver for receiving the transmitted data-signal;
a complementary radio converter for converting the transmitted data-signal to the one or more selected transmission protocols;
a multiplexer for converting the one or more selected transmission protocols to a selected protocol;
a second interfacing unit able to output a selected one of a plurality of different protocol outputs.

2. A wireless communication system apparatus according to claim 1 in which the first interfacing unit is able to interface with a plurality of different protocol inputs including serial port, analogue voice, digital voice, internet modem, Ethernet, and video conferencing.

3. A wireless communication system apparatus according to claim 2 in which the first interfacing unit is able to interface with a plurality of different protocol inputs including:
Serial V.35, V.24, X.21,
analog voice—FXS, FXO, and E&M; 2-wire and 4-wire, voice compression support including
ACELP II (5.8 Kbps, 8 Kbps), G.726 ADPCM (16, 24, 32 & 40 Kbps), G.711 PCM (64 Kbps), and G.729 (8 Kbps) in Release 3.0;
digital voice—T1: digital, ISDN PRI, CAS—T1—up to 24 channels, E1: MFCR-2, R2, CAS—E1—up to 30 channels.
56K, 64K, T1, and E1 DSU.
ISDN BRI—S/T or U interface, data and voice.
V.34 modem.
Ethernet 10BaseT.
Fast Ethernet 100BaseTx.
Token Ring, STP and UTP.
T1 or E1 ATM interface; and
H320 Video Conferencing

4. A wireless communication system apparatus according to claim 1 in which the radio converter by reference to the code modifies the frequency spectrum of the data-signal to be transmitted across the entire bandwidth of the transmittal frequency.

5. A wireless communication system apparatus according to claim 1 in which the code used by the radio converter to modify the frequency spectrum of the data-signal to be transmitted is related to a group of users whereby only the group of users can transmit and receive data-signals from each other.

6. A wireless communication system apparatus according to claim 1 in which the code used by the radio converter to modify the frequency spectrum of the data-signal to be transmitted is related to a single of user whereby only the single user and a main gateway can transmit and receive data-signals from each other, with the gateway able to resend to another user as identified in the data-signal by use of a separate code relevant to the intended recipient.

7. A wireless communication system apparatus according to claim 1 in which the transmission protocol is TCIP/IP.

8. A wireless communication system apparatus according to claim 1 in which the radio transmitter or receiver is connected to an amplifier to increase the power of the transmitted or received data-signals.

9. A wireless communication system apparatus according to claim 1 in which the various transmitters and receivers each having standard operational characteristics and operate at the quality and resolution requirements of the highest of said standard-operational characteristics.

10. A wireless communication system network, including a plurality of wireless communication system apparatuses, for use on unlicensed frequency such as a Code Division Multi Access (CDMA) frequency wherein the apparatuses are able to accept one of a plurality of protocols and convert to a predetermined transmission protocol which by the use of code spread spectrum transmission is able either:
to transmit the signal to a telehouse for receipt and interpretation of the code to resend to another apparatus by code spread spectrum transmission where it is received and selectively converted and outputted into a required one of a plurality of protocols;
or to transmit and be received by one or more other apparatuses encoded with the same transmission code to form a virtual private network where the transmitted signal can be outputted into one of a plurality of protocols.

11. A wireless communication system network according to claim 1 wherein the apparatuses include:
a first interfacing unit able to interface with a selected input from a plurality of different protocol inputs including voice and data inputs as selected at the first interfacing unit;
a multiplexer for converting the various different protocols to one or more predetermined transmission protocols;
a router for prioritizing inputs to determine the order of transmission according to a predetermined priority and system requirements;
a radio converter enabling spread spectrum transmission over a set open multi access frequency, with the converter modifying the frequency spectrum of the data-signal to be transmitted by spreading the signal using a code uncorrelated with that signal;
a radio transmitter for transmitting the spread spectrum data-signal;
a complementary radio receiver for receiving the transmitted data-signal;
a complementary radio converter for converting the transmitted data-signal to the one or more selected transmission protocols;
a multiplexer for converting the one or more selected transmission protocols to a selected protocol;
a second interfacing unit able to output a selected one of a plurality of different protocol outputs.

12. A wireless communication system network according to claim 11 in which the first interfacing unit is able to interface with a plurality of different protocol inputs including serial port, analogue voice, digital voice, Internet modem, Ethernet, and video conferencing.

13. A wireless communication system network according to claim 12 in which the first interfacing unit is able to interface with a plurality of different protocol inputs including:
Serial V.35, V.24, X.21,
analog voice—FXS, FXO, and E&M; 2-wire and 4-wire, voice compression support including
ACELP II (5.8 Kbps, 8 Kbps), G.726 ADPCM (16, 24, 32 & 40 Kbps), G.711 PCM (64 Kbps), and G.729 (8 Kbps) in Release 3.0;
digital voice—T1: digital, ISDN PRI, CAS—T1—up to 24 channels, E1: MFCR-2, R2, CAS—E1—up to 30 channels.
56K, 64K, T1, and E1 DSU.
ISDN BRI—S/T or U interface, data and voice.
V.34 modem.
Ethernet 10BaseT.
Fast Ethernet 100BaseTx.
Token Ring, STP and UTP.
T1 or E1 ATM interface; and
H320 Video Conferencing

14. A wireless communication system network as hereinbefore described with reference to the drawings.

15. A wireless communication system apparatus as hereinbefore described with reference to the drawings.

16. A wireless communication system network, including
a plurality of localised wireless communication system apparatuses interconnectable to form a wireless private network; wherein the wireless private network has at least two types of format for communication from the group including:
Serial V.35, V.24, X.21,
analog voice—FXS, FXO, and E&M; 2-wire and 4-wire, voice compression support including
ACELP II (5.8 Kbps, 8 Kbps), G.726 ADPCM (16, 24, 32 & 40 Kbps), G.711 PCM (64 Kbps), and G.729 (8 Kbps) in Release 3.0;
digital voice—T1: digital, ISDN PRI, CAS—T1—up to 24 channels, E1: MFCR-2, R2, CAS—E1—up to 30 channels.
56K, 64K, T1, and E1 DSU.
ISDN BRI—S/T or U interface, data and voice.
V.34 modem.
Ethernet 10BaseT.
Fast Ethernet 100BaseTx.
Token Ring, STP and UTP.
T1 or E1 ATM interface; and
H320 Video Conferencing
and the various transmitters and receivers each having standard operational characteristics and operate at the quality and resolution requirements of the highest of said standard operational characteristics.

17. A wireless communication system network according to claim 16 with the interconnection via a single transfer protocol to transmit on a wireless frequency such as a Code Division Multi Access (CDMA) frequency wherein the apparatuses are able to accept one of a plurality of protocols and convert to a predetermined transmission protocol which by the use of code spread spectrum transmission is able to transmit the signal to a telehouse apparatus for receipt and interpretation of the code to resend to another apparatus by code spread spectrum transmission where it is received and selectively converted and outputted into a required one of a plurality of protocols.

18. A wireless communication system network according to claim 16 with the network including a plurality of wireless private networks each having a plurality of localised wireless communication system apparatuses and the plurality of wireless private networks being connected through one or more telehouse apparatuses with each able receive and translate each of the plurality of protocols and transmit to and be received by other telehouse apparatuses in the same transmission code to form a wireless virtual private network where the transmitted signal can be outputted into one of a plurality of protocols to a selected one of the plurality of localised wireless communication system apparatuses in its recognizable protocol.

19. A wireless communication system network according to claim 18 with the interconnection via a single transfer protocol to transmit on a wireless frequency such as a Code Division Multi Access (CDMA) frequency wherein the apparatuses are able to accept one of a plurality of protocols and convert to a predetermined transmission protocol which by the use of code spread spectrum transmission is able to transmit the signal to a telehouse apparatus for receipt and interpretation of the code to resend to another apparatus by code spread spectrum transmission where it is received and selectively converted and outputted into a required one of a plurality of protocols.

20. A wireless communication system network according to claim 16 with the network including at least one wireless private network and at least two distantly spaced telehouse apparatuses with each able to transmit and receive by the same transmission code to form a wireless virtual private network and translate the transmitted code to a selected one of a plurality of protocols or vice versa where the transmitted signal can be outputted to a distant communication line system by a selected telehouse apparatus wherein each of the one or more localised wireless communication system apparatuses can form a virtual wireless private network to a telehouse and by single protocol connection to the second distant telehouse be connected to the connected line communication system in its recognized protocol.

21. A wireless communication system network according to claim 20 with the interconnection via a single transfer protocol to transmit on a wireless frequency such as a Code Division Multi Access (CDMA) frequency wherein the apparatuses are able to accept one of a plurality of protocols and convert to a predetermined transmission protocol which by the use of code spread spectrum transmission is able to transmit the signal to a telehouse apparatus for receipt and interpretation of the code to resend to another apparatus by code spread spectrum transmission where it is received and selectively converted and outputted into a required one of a plurality of protocols.

22. A wireless communication system network according to any one of claims 16 to 21 including an apparatus having:
a first interfacing unit able to interface with a selected input from a plurality of different protocol inputs including voice and data inputs as selected at the first interfacing unit;
a multiplexer for converting the various different protocols to one or more predetermined transmission protocols;
a router for prioritizing inputs to determine the order of transmission according to a predetermined priority and system requirements including video and voice being transmitted prior to data;
a radio converter enabling spread spectrum transmission over a set open multi access frequency, with the converter modifying the frequency spectrum of the data-signal to be transmitted by spreading the signal using a code uncorrelated with that signal;
a radio transmitter for transmitting the spread spectrum data-signal;
a complementary radio receiver for receiving the transmitted data-signal;
a complementary radio converter for converting the transmitted data-signal to the one or more selected transmission protocols;
a multiplexer for converting the one or more selected transmission protocols to a selected protocol;
a second interfacing unit able to output a selected one of a plurality of different protocol outputs.

23. A wireless communication system apparatus according to any one of claims 18 to 22 in which the transmission protocol between telehouses is TCIP/IP to form wireless virtual private networks.

24. A wireless communication system network according to claim 22 in which the first interfacing unit is able to interface with a plurality of different protocol inputs including serial port, analogue voice, digital voice, Internet modem, Ethernet, and video conferencing.
